(19) United States
(12) Patent Application Publication
(10) Pub. No.: US 2026/0289161 A1
(43) Pub. Date: Sep. 24, 2026

(54) SYSTEM

(71) Applicant: SoftBank Group Corp., Tokyo (JP)

(72) Inventor: Tomohiro FUJITA, Tokyo (JP)

(73) Assignee: SoftBank Group Corp., Tokyo (JP)

(21) Appl. No.: 19/561,590

(22) Filed: Mar. 10, 2026

(30) Foreign Application Priority Data
Mar. 19, 2025 (JP) 2025-044474

(51) Int. Cl. G06F 40/40; G06F 40/205; G06F 40/253; G06F 40/268; G06F 40/284; G06N 3/0475; G06V 10/40; G06V 10/764; G06V 10/774; G06V 10/82; G06V 20/50

(52) U.S. Cl. CPC G06F 40/40; G06F 40/205; G06F 40/253; G06F 40/268; G06F 40/284; G06N 3/0475; G06V 10/40; G06V 10/764; G06V 10/774; G06V 10/82; G06V 20/50

(57) ABSTRACT

A system includes a processor that is configured to receive information from a user, analyze the received information by using a natural language processing technique, and generate a prompt for instructing a generative artificial intelligence model to classify the information into an appropriate category or tag based on the analyzed information.

### CROSS-REFERENCE TO RELATED APPLICATION

This application is based on and claims priority under 35 USC 119 from Japanese Patent Application No. 2025-044474 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In many existing information management and recommendation systems, users are required to manually select categories and tags for content such as store information, product descriptions, or service descriptions. This manual classification is time-consuming, requires domain knowledge, and often leads to inconsistent or suboptimal categorization. Conventional automatic classification techniques based solely on rule-based or traditional machine learning approaches have limited flexibility when dealing with ambiguous, context-rich natural language expressions frequently used by users. Furthermore, these conventional techniques generally do not leverage recent advances in generative artificial intelligence models, which are capable of understanding nuanced semantics and generating context-appropriate outputs. In addition, existing systems often ignore the user's emotional state or sentiment, even though such emotional context may significantly influence which categories or tags are most appropriate or most useful to the user at a given moment. As a result, there is a need for a system that can automatically classify user-provided information into appropriate categories and tags by effectively combining natural language processing techniques and generative artificial intelligence models, while also being able to adjust its behavior in accordance with the user's emotional state to optimize the proposed categories and tags.

### SUMMARY

In order to solve the above-described problems, the present invention provides a system comprising a processor, wherein the processor is configured to receive information from a user, analyze the received information by using a natural language processing technique, and generate a prompt for instructing a generative artificial intelligence model to classify the information into an appropriate category or tag based on the analyzed information. In this configuration, the processor uses the natural language processing technique to extract semantic features, context, and intent from the user-provided information, and then generates a prompt that is tailored to effectively query the generative artificial intelligence model for classification. The processor is further configured to input the generated prompt into the generative artificial intelligence model and propose one or more categories or tags based on a result returned from the generative artificial intelligence model, thereby leveraging the generative capabilities and contextual understanding of the model to obtain high-quality classification suggestions. Moreover, the processor is configured to analyze an emotion of the user, adjust the generated prompt based on the analyzed emotion of the user, and optimize the proposed category or tag based on the adjusted prompt. By modifying the prompt in accordance with the user's emotional state, the system can, for example, select more conservative or more exploratory tag suggestions, prioritize certain types of categories, or alter the level of detail in the classification, thereby providing categories and tags that are better aligned with the user's expectations and situational needs.

The term “system” refers to an arrangement of one or more hardware components and software components that cooperate to perform information processing operations as described in the claims.

The term “processor” refers to one or more hardware processing units, such as a central processing unit (CPU), a graphics processing unit (GPU), or a specialized accelerator, optionally operating together with firmware or software, that execute instructions to perform the functions recited in the claims.

The term “user” refers to a human operator or an entity acting on behalf of a human operator that provides information to the system and receives output, such as proposed categories or tags, from the system.

The term “information” refers to data provided by the user in natural language or other expressive forms, including but not limited to text describing products, services, stores, content items, or user intentions, which is to be analyzed and classified by the system.

The term “natural language processing technique” refers to any computational method or algorithm for processing and analyzing human language, including but not limited to tokenization, part-of-speech tagging, syntactic parsing, named entity recognition, sentiment analysis, embedding generation, or semantic similarity analysis.

The term “generate a prompt” refers to creating, by the processor, a text input or other structured input that is formatted and arranged so as to instruct a generative artificial intelligence model to perform a specific task, such as classification of user-provided information into categories or tags.

The term “prompt” refers to a sequence of characters, tokens, or symbols, including optional instructions, examples, or context, that is provided as input to a generative artificial intelligence model to cause the model to generate an output relevant to a requested task.

The term “generative artificial intelligence model” refers to a machine learning model, such as a large language model or other generative model, that is configured to generate text or other outputs in response to an input prompt, and that can be used to perform or assist in classification of information into categories or tags.

The term “classify” refers to the act of assigning one or more labels, such as categories or tags, to the information based on its content, context, or inferred meaning.

The term “category” refers to a label representing a class, type, or group to which the information belongs at a relatively high or intermediate level of abstraction, such as “Restaurant,” “Electronics,” or “Clothing.”

The term “tag” refers to a label representing an attribute, feature, topic, or characteristic of the information, which may be more fine-grained than a category, such as “Italian,” “Casual,” “Dinner,” or “Noise-cancelling.”

The term “appropriate category or tag” refers to a category or tag that is relevant and suitable to describe the content, context, or intended use of the information provided by the user, as determined by the processing steps recited in the claims.

The term “input the generated prompt into the generative artificial intelligence model” refers to causing the generated prompt to be supplied as input data to the generative artificial intelligence model so that the model processes the prompt and produces a corresponding output.

The term “result returned from the generative artificial intelligence model” refers to an output produced by the generative artificial intelligence model in response to a prompt, including, for example, text suggesting categories or tags or other intermediate data from which such suggestions can be derived.

The term “propose one or more categories or tags” refers to generating, by the processor, candidate categories or tags to be presented to the user or stored in association with the information, based at least in part on the result returned from the generative artificial intelligence model.

The term “emotion of the user” refers to an affective state or sentiment of the user, such as happiness, frustration, interest, or disinterest, which is inferred or determined from user-provided data, user behavior, or other observable signals.

The term “analyze an emotion of the user” refers to processing, by the processor, one or more inputs related to the user, such as textual content, voice data, interaction patterns, or explicit feedback, to infer or estimate the emotional state or sentiment of the user.

The term “adjust the generated prompt based on the analyzed emotion” refers to modifying, by the processor, at least part of the content, style, parameters, or constraints of a prompt in response to the inferred user emotion, so that the behavior of the generative artificial intelligence model is influenced by the user's emotional state.

The term “optimize the proposed category or tag” refers to selecting, modifying, reordering, filtering, or otherwise refining categories or tags, by the processor, such that the final proposed categories or tags more closely match the user's needs, preferences, or emotional context compared to unoptimized proposals.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

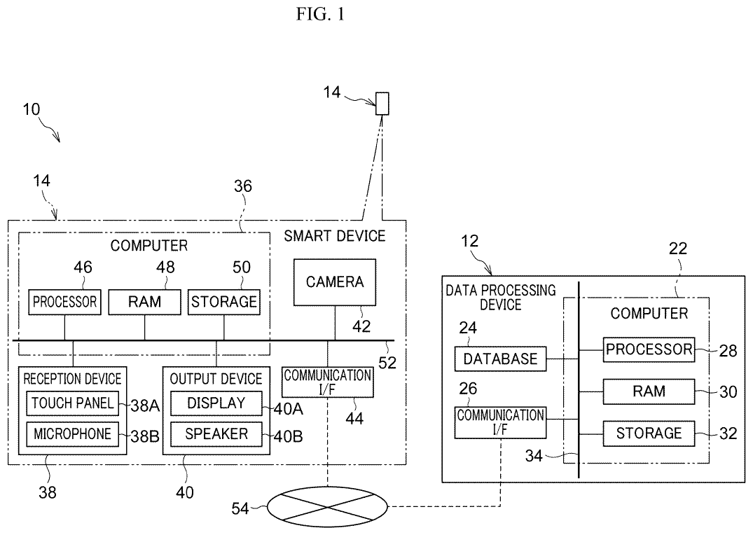

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

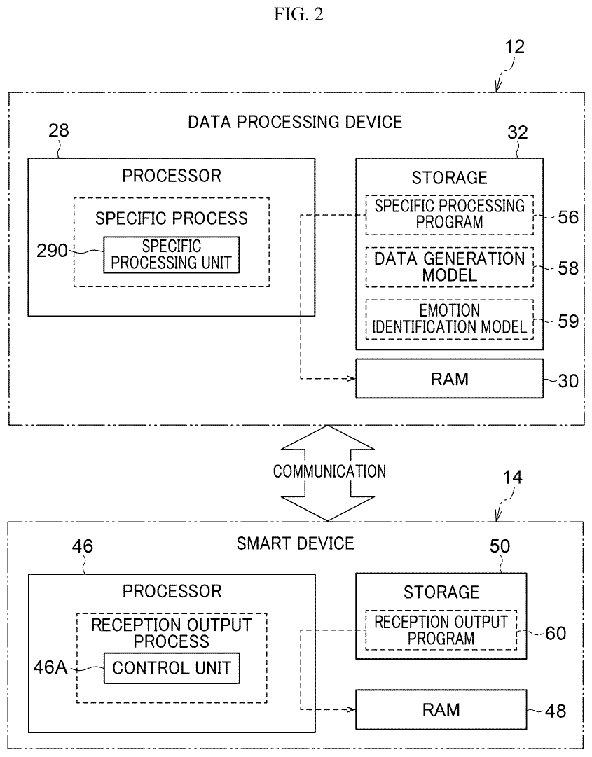

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information management systems that classify user-provided text into categories and tags typically rely on either rule-based logic or a single machine learning model operating on preprocessed text. Such systems often suffer from limited adaptability to new domains, degraded accuracy for noisy or short user inputs, and an inability to flexibly incorporate contextual information such as past user confirmations or inferred user preferences. When these systems are integrated with a generative AI model, the integration is frequently ad hoc, in that the generative model is merely called with a fixed prompt that does not reflect the internal feature representations, model outputs, or user feedback accumulated by the system. As a result, the generative AI model is not effectively aligned with the system's classification objectives, leading to unstable quality of suggested categories and tags and increased need for manual correction by users.

Furthermore, existing systems generally treat prompts to generative AI models as static text templates, without programmatically optimizing the prompt contents and structure based on computed feature quantities, classification results, historical confirmation data, or user state. This static handling of prompts limits the ability of the system to improve the inference performance of the generative AI model over time and to reduce computational waste. In particular, the system cannot systematically filter or refine the generative AI model's output against the outputs of a discriminative classifier, which means misaligned or redundant tags are often presented to the user.

In addition, conventional techniques rarely consider the user's emotional state or interaction context when generating prompts or selecting the type and number of suggested categories and tags. As a consequence, users may be overwhelmed with irrelevant suggestions or may not receive sufficient guidance when they need it, leading to poor human-computer interaction, reduced user trust, and inefficiencies in the data labeling workflow. From a computer technology perspective, these shortcomings manifest as suboptimal use of computing resources, insufficient exploitation of intermediate machine learning artifacts (such as feature vectors and classification scores), and lack of a coherent architecture for combining discriminative models with generative AI models in a feedback-aware and context-aware manner.

Accordingly, there is a need for a technical solution that improves the functioning of a computer system configured for text classification, by (i) systematically preprocessing and vectorizing user input text, (ii) coordinating a classification learning unit and a generative AI model through structured prompt sentences that encode internal features and past confirmations, (iii) integrating the outputs of these heterogeneous models to produce higher-quality proposals of categories and tags, and (iv) adaptively controlling prompt generation and output selection based on user feedback and inferred emotional state. Such a solution should reduce manual correction load, enhance classification accuracy and stability, and more efficiently utilize computing resources within the system.

The specific processing by the specific processing unit 290 of the data processing device 12 in Example 1 is realized by the following means.

The present invention provides a server comprising a processor configured to receive character information from a user, preprocess the received character information by performing natural language processing including morphological analysis and removal of unnecessary terms, generate a feature quantity by creating a weighted vector from the preprocessed character information, estimate at least one category and at least one tag by inputting the weighted vector into a classification learning unit, generate a prompt sentence that describes processing contents for estimating the category and the tag, generate instruction information for inputting the prompt sentence into a generative information processing model, select candidates for the category and the tag based on response information returned from the generative information processing model, integrate the candidates with an estimation result from the classification learning unit to determine the category and the tag as proposal information, present the determined category and tag to the user and receive correction input from the user, and store the proposal information as confirmed information in a storage unit in a format usable as training data for the classification learning unit and the generative information processing model. This enables an improved computer-implemented classification architecture in which internal feature representations and classifier outputs are programmatically reflected in dynamically generated prompt sentences for a generative AI model, the outputs of discriminative and generative models are coherently integrated, and user feedback is fed back into both models, thereby enhancing accuracy and stability of category and tag proposals, reducing user correction effort, and improving the overall functioning and efficiency of the text processing system.

The term “character information” refers to information represented as a sequence of symbols, such as letters, numerals, punctuation marks, or other textual symbols, that can be input, processed, and stored by an information processing apparatus.

The term “user” refers to a human operator or an entity that provides character information to the system and receives category or tag proposals from the system via an input/output interface.

The term “information input unit” refers to a hardware component, software component, or combination thereof, configured to receive character information from a user, such as a graphical user interface, a text input field, an application programming interface, or a communication interface.

The term “analysis unit” refers to a hardware component, software component, or combination thereof, configured to perform natural language processing on character information, including at least morphological analysis, tokenization, and removal of unnecessary terms.

The term “natural language processing” refers to a sequence of computational operations for analyzing human language text, including at least one of tokenization, morphological analysis, part-of-speech tagging, stop-word removal, normalization, or syntactic parsing.

The term “morphological analysis” refers to processing that segments a text into morphemes or tokens and determines grammatical or lexical information associated with the tokens, such as part of speech or base form.

The term “unnecessary terms” refers to tokens, symbols, or expressions in character information that are determined not to contribute significantly to classification or tagging, such as function words, common stop words, or punctuation marks.

The term “feature quantity” refers to a numerical representation of preprocessed character information, such as a vector or matrix, that encodes statistical or semantic properties of the text for use in machine learning.

The term “weighted vector” refers to a numerical vector whose elements each correspond to a feature derived from character information and whose values represent weights, such as term frequency-inverse document frequency weights, indicating importance of the features.

The term “feature extraction unit” refers to a hardware component, software component, or combination thereof, configured to convert preprocessed character information into at least one feature quantity, including generation of a weighted vector.

The term “classification learning unit” refers to a hardware component, software component, or combination thereof, configured to apply a trained discriminative model to a feature quantity to estimate at least one category and at least one tag for input character information.

The term “category” refers to a label representing a higher-level classification or type to which the content of character information belongs, such as a business type, product class, or domain group.

The term “tag” refers to a label representing a descriptive attribute, keyword, or topic associated with the content of character information, which may be used for indexing, searching, or recommendation.

The term “prompt sentence” refers to a text string or structured natural language instruction that describes a processing context, a task, or constraints, and that is provided as input to a generative information processing model to cause the model to generate an output related to categories or tags.

The term “instruction information” refers to data specifying that a particular prompt sentence is to be input to a generative information processing model and optionally including control parameters such as model identifier, temperature, or maximum output length.

The term “generative information processing model” refers to a machine learning model, such as a generative AI model, configured to generate text or other structured output in response to a prompt sentence, based on learned probabilistic relationships in training data.

The term “response information” refers to output data, such as generated text or structured labels, returned from a generative information processing model in response to a prompt sentence and used as candidates for categories or tags.

The term “prompt generation unit” refers to a hardware component, software component, or combination thereof, configured to construct, modify, or format a prompt sentence and to generate corresponding instruction information for a generative information processing model.

The term “integration unit” refers to a hardware component, software component, or combination thereof, configured to combine or reconcile candidates for categories and tags obtained from a generative information processing model with estimation results from a classification learning unit to determine proposal information.

The term “proposal information” refers to information including one or more categories and one or more tags that have been determined by integrating outputs of a classification learning unit and a generative information processing model and that are presented to a user as suggested labels.

The term “display unit” refers to a hardware component, software component, or combination thereof, configured to visually or otherwise output proposal information to a user, such as a screen, a graphical user interface, or a web browser.

The term “user interface unit” refers to a hardware component, software component, or combination thereof, configured to mediate interaction between the user and the system, including presentation of information and reception of user inputs such as corrections to categories and tags.

The term “correction input” refers to user-provided modification, confirmation, deletion, or addition relating to proposed categories or tags, entered via the user interface unit.

The term “storage unit” refers to a hardware component, software component, or combination thereof, configured to hold data persistently or semi-persistently, such as a memory device, a database system, or a file storage system.

The term “storage control unit” refers to a hardware component, software component, or combination thereof, configured to control writing, updating, and reading of data in the storage unit, including storing proposal information as confirmed information.

The term “confirmed information” refers to information that reflects categories and tags after consideration of correction input from the user and that is stored as final label data for corresponding character information.

The term “training data” refers to data composed of input character information and associated label information, such as confirmed categories and tags, that is used to train, retrain, or fine-tune a classification learning unit or a generative information processing model.

The term “commercial entity” refers to an economic actor or business unit, such as a store, service provider, or organization, whose information can be expressed as character information and classified into categories or tags.

The term “operation history information” refers to data representing sequences of user interactions with the system, such as inputs, selections, corrections, and navigation actions, recorded over time.

The term “reaction information” refers to data representing observable user responses to system outputs, such as response time, acceptance rate of suggested tags, or explicit feedback signals.

The term “emotional state” refers to an inferred affective condition of the user, such as satisfaction, frustration, or uncertainty, estimated from operation history information or reaction information.

The term “request conditions” refers to constraints, parameters, or instructions included in a prompt sentence that specify requirements for the output of a generative information processing model, such as desired number of tags, language, style, or specificity level.

In one embodiment, a server implements the claimed system as a network-accessible classification platform that cooperates with one or more terminals operated by users. The server comprises at least one central processing unit (CPU), a memory device, a network interface, and a non-transitory storage device, and executes an operating system such as a UNIX-like operating system. The server executes an application program including a natural language processing module, a feature extraction module, a classification learning module, a generative AI interface module, a prompt generation module, an integration module, and a storage control module. The server communicates with terminals via a communication network using a protocol such as HTTPS.

The terminal provides an information input unit and a display unit, for example by executing a web browser or a native client application on a computing device such as a smartphone or a personal computer. The terminal presents input fields for character information such as a commercial entity name and a description, and transmits the entered character information to the server as structured data. The terminal receives from the server proposal information including categories and tags and displays such proposal information to the user. The terminal further provides a user interface unit that allows the user to perform correction input with respect to the proposed categories and tags.

The user operates the terminal to input character information and to confirm or correct the categories and tags suggested by the server. The user may input, for example, a commercial entity name and a description of services or products. In one example, the user inputs the following character information at the terminal:

Store name: Café de Paris

Description: A French-style cafe where croissants and coffee are popular.

The server receives this character information as part of a request, stores the raw text in the storage device as original input data, and processes the character information using the modules described below.

The server uses a natural language processing module executed on the CPU and implemented, for example, by a programming language runtime and a natural language processing library such as a tokenization and morphological analysis toolkit. The server performs morphological analysis on the received character information to segment the text into tokens, and identifies linguistic attributes such as parts of speech. The server removes unnecessary terms such as stop words, punctuation, and tokens that do not contribute to classification performance. The server optionally normalizes tokens, such as by converting to lowercase or by applying stemming or lemmatization. The resulting preprocessed text is stored in a memory-resident data structure such as a list of tokens.

The server converts the preprocessed text into a feature quantity using a feature extraction module. The server uses an algorithm such as a term frequency-inverse document frequency (TF-IDF) computation implemented by a numerical computation library. The server constructs a vocabulary of terms and assigns each term an index in a vector space. The server computes, for each term in the preprocessed text, a term frequency component and an inverse document frequency component, and multiplies these components to obtain a weight. The server stores the resulting weighted vector as a sparse numeric vector or matrix in memory. In alternate embodiments, the server uses other feature extraction techniques, such as word embedding vectors, subword n-gram vectors, or contextual embedding representations produced by a neural network encoder.

The server uses a classification learning module to estimate at least one category and at least one tag from the feature quantity. In one embodiment, the server employs a discriminative machine learning model such as a support vector machine or an ensemble classifier. The server loads trained model parameters from the storage device into memory at startup. The server inputs the feature vector into this discriminative model and computes, using floating-point arithmetic on the CPU, decision scores for multiple possible categories and tags. The server selects one or more categories and tags whose scores exceed a predefined threshold or whose rank is highest, and stores these as an intermediate estimation result.

In another embodiment, the server uses a neural network classifier as the classification learning module. The server implements, for example, a feedforward neural network or a convolutional neural network that accepts a feature vector as input and generates output logits corresponding to categories and tags. The server trains this neural network prior to deployment by applying supervised learning with labeled datasets. The server minimizes an error function such as cross-entropy loss by iteratively updating network weights using an optimization algorithm such as stochastic gradient descent or Adam. The server applies regularization techniques such as dropout or weight decay, and may use data augmentation such as synonym replacement or noise injection in training texts to improve generalization. The server stores the trained network weights and hyperparameters in the storage device and loads them into the classification learning module at runtime.

The server generates a prompt sentence to be used by a generative AI model by using a prompt generation module. The server constructs the prompt sentence as a natural language text that encodes: (i) the character information received from the user, (ii) the feature quantity or a summary of the feature quantity, (iii) the current estimation result from the classification learning module, and (iv) past confirmed information associated with similar inputs. The server may dynamically insert or omit portions of this information depending on context, thereby generating a prompt sentence that guides the generative AI model toward producing relevant category and tag candidates.

The server uses a generative AI interface module to transmit the prompt sentence and instruction information to a generative AI model. In one embodiment, the server accesses an external generative AI model over the network by sending the prompt sentence and associated parameters to an inference endpoint. In another embodiment, the server executes a generative neural network locally, such as a transformer-based language model. The generative AI model comprises multiple layers of self-attention and feedforward sublayers, with parameters learned from large-scale text corpora. During inference, the model uses the prompt sentence as input, computes attention weights across tokens, and generates output tokens one by one, thereby producing response information that includes suggested categories, tags, and explanations.

An example of a prompt sentence used by the server is as follows:
Store name: Café de Paris
Description: A French-style cafe where croissants and coffee are popular.
Current predicted category: cafe
Current predicted tags: French cuisine
Past confirmed tags for similar stores: bakery, breakfast, coffee

Please propose up to 5 refined categories and up to 10 refined tags in English that best describe this store. Output only the list of categories and tags.

The server receives response information from the generative AI model, parses the response information, and extracts candidate categories and tags. The server then uses the integration module to combine these candidates with the estimation results from the classification learning module. The server may apply non-conventional rules for integration, such as:
assigning higher weight to labels that are consistent across both models,
discarding labels whose generative probability is high but whose discriminative score is below a threshold,
promoting labels that frequently appear in past confirmed information for similar feature vectors, and
limiting the total number of proposed labels according to confidence levels and user interface constraints.

The server thus produces proposal information comprising an integrated set of categories and tags, together with internal confidence scores and provenance indicators. The server stores these in an internal data structure such as a record including fields for raw text, feature vector identifiers, classifier scores, generative scores, and integration decisions.

The server transmits the proposal information to the terminal. The terminal displays, for example, a main category suggestion such as “cafe” and additional tags such as “French cuisine,” “bakery,” “coffee,” and “breakfast.” The user can accept or modify each tag through the user interface. The terminal transmits the user's correction input back to the server.

The server receives the correction input, updates the proposal information, and stores the resulting labels as confirmed information in the storage unit. The server maintains a data schema in which each record associates a unique input identifier with the original character information, the final confirmed categories and tags, and metadata such as timestamps and user identifiers. The server uses this confirmed information as training data for retraining or fine-tuning both the classification learning module and the generative AI model. For example, the server periodically executes a background training process that selects confirmed records, recomputes feature vectors, and updates classifier weights by minimizing a loss function; or constructs additional prompt-output pairs for use in fine-tuning a transformer-based generative model.

The server optionally estimates an emotional state of the user based on operation history information and reaction information. The server collects metrics such as time taken to accept suggestions, frequency of corrections, and explicit feedback ratings. The server uses a statistical or neural model to map these metrics to an emotional state such as “confused,” “satisfied,” or “overloaded.” Based on the inferred emotional state, the server adjusts the vocabulary, style, and request conditions in subsequent prompt sentences. For example, if the user frequently rejects suggested tags, the server may tighten the confidence thresholds in the integration module, request fewer tags from the generative AI model, and add explicit instructions in the prompt sentence to avoid generic or redundant tags. This adaptive behavior reduces the cognitive load on the user and makes the computer system more responsive to user context.

From a computer-technology perspective, the server improves the functioning of the underlying computing system in several ways. By converting character information into structured feature quantities and reusing these feature quantities both for discriminative classification and for constructing information-rich prompt sentences, the server reduces redundant computation and improves processing speed. The server avoids naive, static prompts that ignore internal model states and instead uses non-conventional prompt construction rules that incorporate feature indices, classifier confidence distributions, and historical label statistics. This approach increases the alignment between the generative AI model and the discriminative model, thereby improving the precision and recall of suggested categories and tags.

The server further reduces communication load and computation cost by controlling how many candidates are requested from the generative AI model and by filtering generative outputs using discriminative scores before sending results to the terminal. Because the generative AI model can be computationally expensive, this coordinated approach minimizes unnecessary generations while still providing high-quality suggestions. The server's integration of classifier and generative outputs leads to fewer iterations of user correction, thereby reducing the total number of server-terminal communication cycles and improving overall throughput of the system.

In addition, the server applies training methods that explicitly exploit confirmed information as label data. The server uses error functions such as cross-entropy loss or margin-based losses to update parameters of the classification learning module, and may use reinforcement learning or instruction tuning on prompt-answer pairs to refine the generative AI model. The server maintains specific data structures, such as mapping tables from feature-vector hashes to confirmed tags, that allow efficient retrieval of similar past cases during prompt generation and integration. These data structures and algorithms are not a mere automation of human judgment but represent a specific computational technique for organizing, retrieving, and using model-internal and user-feedback data to modify both discriminative and generative behavior.

In alternative embodiments, the server changes the type of feature quantity while preserving the overall architecture. For example, the server may use a neural embedding model to encode the preprocessed text into a fixed-dimensional dense vector and use that vector both for classifier input and as compact context information in the prompt sentence. In another variant, the server may arrange feature quantities and label statistics into a structured context block appended to the prompt sentence in a machine-readable format, enabling the generative AI model to interpret classifier confidence and frequency-based signals directly. These variations maintain the same technical effect of improving classification accuracy and computational efficiency by tightly coupling internal representations with generative prompting and integration logic.

The user, by interacting with the terminal, indirectly participates in a feedback loop that continuously improves the underlying computer models. However, the determination of categories and tags is not delegated to the user; instead, the server executes non-trivial algorithms that combine natural language processing, vectorization, discriminative classification, generative modeling, and integration rules. This configuration yields technical effects such as reduced classification error, faster convergence of model training, reduced network bandwidth due to fewer correction cycles, and improved stability of results across heterogeneous input texts.

Thus, the described embodiment provides a concrete, computer-centric implementation of a system in which a server, terminals, and users cooperate to classify character information. Through the specific use of natural language processing techniques, feature quantity computation, classifier architectures, generative AI model interaction via dynamically constructed prompt sentences, and an integration mechanism informed by user feedback and emotional state estimation, the system improves the operation of the computer itself rather than merely automating a human mental process.

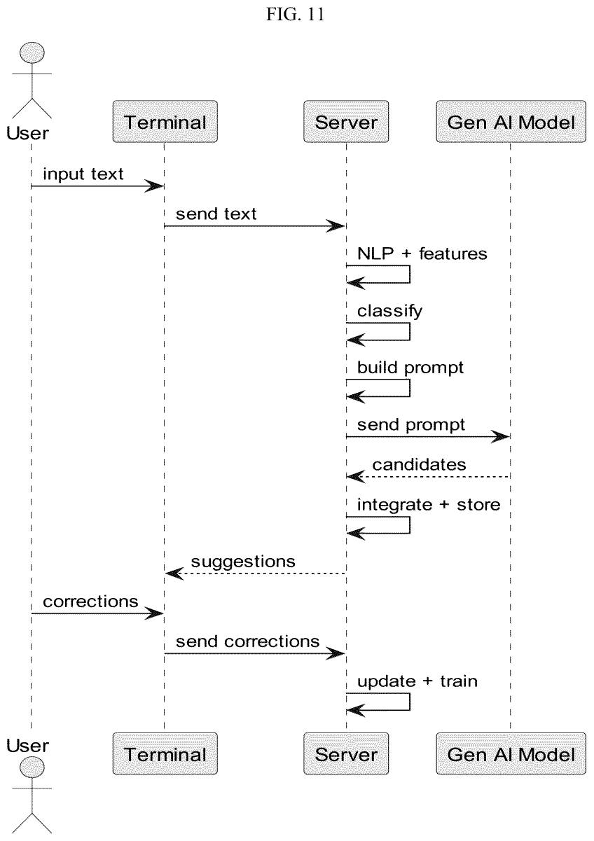

The following describes the processing flow using FIG. 11.

### Step 1:

The user operates the terminal to input character information. The user opens an input screen on the terminal, places a cursor in an input field, and types information such as a commercial entity name and a description of services or products. The user then activates a send control (for example, a “Submit” button). The input of this step is raw character information entered by the user, and the output of this step is structured input data held in the terminal's memory, such as a pair of text strings representing the name and the description.

### Step 2:

The terminal converts the structured input data into a request message and transmits the request to the server. The terminal takes the name and description strings as input, packages them into a data structure, and serializes this structure into a format suitable for network transmission, such as text encoded in a request body. The terminal performs data processing that includes character encoding conversion and addition of metadata such as a session identifier. The output of this step is a network request containing the character information, transmitted from the terminal to the server over a communication channel.

### Step 3:

The server receives the network request and extracts the raw character information. The server accepts the incoming connection via a network interface, decodes the request message, and parses the request body. The input of this step is the serialized network request from the terminal, and the server performs data parsing to identify fields corresponding to the commercial entity name and description. The output of this step is a set of raw text strings stored in server memory as original character information.

### Step 4:

The server stores the original character information and associated metadata in a storage unit. The server takes the raw text strings and metadata (such as timestamps and user identifiers) as input, constructs a record compliant with an internal data schema, and issues a write operation to a database or file system. The server performs data processing that includes formatting the text, assigning a unique record identifier, and indexing certain fields for later retrieval. The output of this step is a persistent record of the original character information held in the storage unit.

### Step 5:

The server preprocesses the character information using natural language processing. The server takes the raw text strings as input, applies tokenization, morphological analysis, and removal of unnecessary terms, and produces a cleaned representation. The server executes data operations such as splitting the text into tokens, assigning part-of-speech tags, lowercasing tokens, and filtering out stop words and punctuation. The output of this step is preprocessed text data, represented for example as a sequence of meaningful tokens ready for feature extraction.

### Step 6:

The server converts the preprocessed text into a feature quantity. The server takes the sequence of tokens as input and applies a feature extraction algorithm, such as term frequency-inverse document frequency computation or embedding generation. The server calculates numeric weights for terms by counting occurrences, applying logarithmic scaling, and combining these counts with global frequency statistics. The data processing yields a weighted vector in which each dimension corresponds to a term index and each value corresponds to a computed weight. The output of this step is one or more feature vectors stored in memory as numeric arrays or sparse matrices.

### Step 7:

The server estimates categories and tags using a classification learning unit. The server takes the feature vectors as input and feeds them into a trained discriminative model such as a support vector machine, an ensemble classifier, or a neural network classifier. The server performs data computations that include matrix multiplications, evaluation of decision functions, or propagation through network layers. The output of this step is an initial set of predicted categories and tags, together with associated scores or probabilities, stored as structured data in the server's memory.

### Step 8:

The server retrieves past confirmed information relevant to the current feature vectors. The server takes the current feature vectors or their identifiers as input, queries the storage unit using similarity criteria or index lookups, and selects records with similar feature patterns or categories. The server performs data processing that includes computing similarity metrics or executing database queries. The output of this step is a collection of past confirmed categories and tags associated with similar inputs, represented as structured label data.

### Step 9:

The server generates a prompt sentence for a generative AI model. The server takes as input the original character information, the preprocessed text summary, the feature vectors, the initial predicted categories and tags, and the retrieved past confirmed information. The server performs data operations such as string formatting, insertion of variable fields, and ordering of content according to a template. The server constructs a prompt sentence that instructs the generative AI model to propose refined categories and tags. The output of this step is a complete prompt sentence stored as a text string in memory, along with any instruction parameters for model invocation.

### Step 10:

The server transmits the prompt sentence to a generative AI model and obtains response information. The server takes the prompt sentence and instruction parameters as input, sends them either to an external generative AI endpoint or to a locally executed generative model, and triggers inference. The server performs data operations that include encoding the prompt, invoking model computation, and decoding the model's generated tokens. The output of this step is response information containing candidate categories and tags expressed as text, stored as structured output from the generative AI model.

### Step 11:

The server parses the response information and extracts candidate categories and tags. The server takes the generated text as input and applies text parsing operations to identify individual labels, such as splitting by delimiters or applying pattern matching. The server normalizes the extracted labels, for example by trimming whitespace and converting case. The output of this step is a list of candidate categories and tags derived from the generative AI model, stored in a structured format in memory.

### Step 12:

The server integrates the candidates from the generative AI model with the classification learning unit's estimation results. The server takes as input the initial predicted categories and tags with their scores, the candidate categories and tags from the generative AI model, and optionally the past confirmed information. The server performs data processing that includes comparing labels, aggregating scores, applying weighting rules, and eliminating duplicates or low-confidence labels. The server may compute combined confidence values and apply thresholds to select a final subset. The output of this step is proposal information comprising a coherent set of categories and tags, each associated with an integration decision and confidence indicator.

### Step 13:

The server estimates a user emotional state and adjusts subsequent prompts and proposals. The server takes as input operation history information and reaction information, such as counts of accepted suggestions, number of corrections, and response times. The server performs data analysis by computing derived metrics and optionally applying a statistical or neural model to map these metrics to an emotional state category. The server then modifies internal parameters such as how many tags to request from the generative AI model or how strict to make integration thresholds. The output of this step is an updated context state that influences future prompt sentence generation and proposal selection.

### Step 14:

The server sends the proposal information to the terminal for presentation to the user. The server takes the integrated categories and tags, together with any explanatory text, as input and serializes this data for network transmission. The server formats a response message including the proposal information and performs data processing that includes encoding and packaging. The output of this step is a response transmitted over the communication network from the server to the terminal.

### Step 15:

The terminal receives the response and displays the proposed categories and tags to the user. The terminal takes the response message as input, parses the included structured data, and maps each proposed category and tag to visual elements such as labels or selectable items on a screen. The terminal performs data processing that includes JSON or text parsing and graphical layout rendering. The output of this step is a user interface state in which the proposals are visible and interactable for the user.

### Step 16:

The user reviews the proposed categories and tags and performs correction input if necessary. The user takes the displayed proposals as input in a cognitive sense, decides which categories and tags to accept or modify, and operates the terminal, for example by selecting check boxes, deleting labels, or entering new tags. The output of this step is correction input data captured by the terminal, including confirmation, deletions, and additions requested by the user.

### Step 17:

The terminal sends the correction input to the server. The terminal takes the user's correction operations as input, transforms them into a structured representation such as a list of accepted labels and a list of changes, and packages this representation into a request message. The terminal performs data serialization and transmits the message over the network. The output of this step is a correction request delivered to the server containing final label decisions.

### Step 18:

The server updates proposal information and stores confirmed information as training data. The server takes the correction request as input, merges the user's decisions with the existing proposal information, and finalizes the categories and tags. The server performs data processing that includes updating record fields, marking proposals as confirmed, and associating them with the original character information. The server writes the confirmed information into the storage unit and links it to model-specific data structures for future training and evaluation. The output of this step is an updated set of persisted records that include confirmed labels and are usable as training data for the classification learning unit and the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In electronic commerce platforms and other information management environments, classification of items or services into appropriate categories and tags is essential for search efficiency, recommendation accuracy, and overall user experience. Conventional systems generally rely on manual selection of categories and tags by end users or by human operators through graphical user interfaces. Such manual classification often leads to inconsistent labeling, low coverage of relevant tags, and increased latency in registering or updating item information. Furthermore, as the number of items and the complexity of taxonomies grow, manual workflows do not scale and tend to cause higher error rates and increased operational cost.

Certain existing automatic or semi-automatic classification techniques apply basic rule-based methods or conventional machine learning models that directly map input text to fixed labels. These techniques typically require extensive feature engineering and static model deployment, and they are not easily adaptable to changes in taxonomy or user behavior. In addition, conventional approaches generally do not exploit rich prompt-based interaction with advanced generative AI models, nor do they systematically close the loop between user feedback and model behavior. As a result, these approaches suffer from limited flexibility, poor explainability of classification suggestions, and slow convergence of model performance over time.

From a computer technology standpoint, there is a need to improve how computing systems orchestrate natural language preprocessing, prompt construction, generative AI inference, and user feedback integration in a unified, machine-implemented pipeline. In particular, there is a need for a processor-controlled architecture that (i) transforms raw user-entered character information into structured numerical feature data, (ii) builds and formats prompt sentences as inputs to a generative AI model in a consistent and machine-efficient manner, (iii) automatically produces ranked candidate categories and tags with associated confidence information, and (iv) continuously refines the underlying model using logged interactions and user-confirmed final classifications.

The technical problem to be solved is therefore to provide a computer-implemented system that improves the functioning of the computer itself in performing classification operations by: reducing reliance on manual, error-prone category selection; enabling scalable, low-latency classification suggestion generation; and providing an automated feedback and retraining mechanism that incrementally enhances the performance of a generative AI model without requiring manual reconfiguration of classification rules. The problem further includes how to structure server-side processing so that prompt generation, model invocation, result post-processing, and model refinement are executed in a coordinated and resource-efficient way, thereby improving throughput, accuracy, and robustness of classification operations in large-scale information systems.

The specific processing by the specific processing unit 290 of the data processing device 12 in Application Example 1 is realized by the following means.

The present invention provides a server comprising a processor configured to receive character information including identification information relating to an item or a service from a user terminal via an external input/output interface, preprocess the received character information by using a natural language processing technique including at least morphological analysis, phrase segmentation, part-of-speech assignment, and feature extraction so as to generate numerical feature data suitable for machine learning-based classification, generate a prompt sentence including an instruction statement for estimating at least one category or tag for the item or the service in a commerce environment on the basis of the character information and the numerical feature data, format the prompt sentence as input data for a generative artificial intelligence model, operate the generative artificial intelligence model on a machine learning platform to execute matrix computation and probability estimation processing based on the input data and to obtain classification result data including candidate categories and candidate tags and confidence information corresponding to the candidate categories and the candidate tags, perform ranking and threshold determination on the classification result data on the basis of the confidence information and perform normalization processing including association of the candidate categories and the candidate tags with internal identifiers so as to generate classification candidate information, transmit the classification candidate information to the user terminal to cause a display function of the user terminal to present the classification candidate information as selectable candidates, obtain final classification information including a correction result or an approval result received from a user via the user terminal, register the final classification information in a storage device in association with the item or the service, accumulate the final classification information together with the character information and the prompt sentence as learning history data, and retrain or adjust performance of the generative artificial intelligence model on the basis of the accumulated learning history data and reflect an update result of the retraining or the adjustment in subsequent classification processing. This enables a computer-implemented classification pipeline in which the server automatically converts unstructured user input into optimized prompt sentences and numerical feature data, leverages a generative AI model to produce high-quality, ranked category and tag candidates, and continuously improves model behavior through integrated feedback and retraining, thereby enhancing the technical performance, scalability, and accuracy of classification processes executed by the computing system.

The term “processor” refers to a hardware computing element, such as a central processing unit or an execution core, that is configured to execute instructions stored in a memory to perform logical, arithmetic, control, and input/output operations required to implement the functions of the system.

The term “user terminal” refers to an information processing device operated by a user, such as a personal computer, a smartphone, or a tablet device, that is configured to transmit character information to the server and to display classification candidate information and final classification information.

The term “character information” refers to information expressed as a sequence of characters, symbols, or text strings, including at least a product name, a service name, a description, or other textual identification information input by a user.

The term “identification information” refers to information that enables a particular item or service to be distinguished from other items or services, including at least a name, a title, or a descriptive text associated with the item or service.

The term “item” refers to a physical or digital good, commodity, or object that can be registered, searched, or transacted in an information management environment.

The term “service” refers to an activity, function, or offering that is provided to a user or customer and that can be registered, searched, or transacted in an information management environment.

The term “external input/output function” refers to a hardware and software interface, such as a network interface, communication module, or input/output controller, that enables the processor to exchange data with external devices including user terminals.

The term “natural language processing technique” refers to a set of algorithms and software procedures that analyze, transform, or interpret human language text, including operations such as tokenization, morphological analysis, syntactic analysis, semantic analysis, and feature extraction.

The term “morphological analysis” refers to processing that segments text into minimal meaningful units and determines attributes such as base forms and inflectional features of words or tokens contained in the text.

The term “phrase segmentation” refers to processing that divides text into phrases or segments based on linguistic criteria, such as word boundaries, syntactic structure, or semantic units, for use in subsequent analysis or feature extraction.

The term “part-of-speech assignment” refers to processing that assigns grammatical category labels, such as noun, verb, adjective, or adverb, to each token or word in text.

The term “feature extraction” refers to processing that converts text or tokens into numerical or symbolic representations, such as vectors, indices, or structured attributes, that can be used as input to a machine learning model.

The term “numerical feature data” refers to data represented as numerical values, such as vectors, matrices, or tensors, that encode features derived from character information and that are suitable for processing by a machine learning model.

The term “prompt sentence” refers to a text string or instruction statement, formatted in natural language or a structured representation, that specifies a task, a context, or constraints and that is provided as input to a generative artificial intelligence model to induce a desired output.

The term “generative artificial intelligence model” refers to a machine learning model, such as a neural network, that is configured to generate or predict output data, including text or labels, based on input data and learned parameters, and that is capable of producing new content or inferences not explicitly stored in training data.

The term “machine learning platform” refers to a software and hardware environment configured to execute machine learning models, including runtime libraries, execution engines, and computational resources such as processors, accelerators, and memory.

The term “input data for a generative artificial intelligence model” refers to data structures, including tokenized prompt sentences, numerical feature data, or encoded representations, that are formatted according to the requirements of a generative artificial intelligence model and are supplied to the model for inference.

The term “matrix computation” refers to numerical operations performed on matrices or tensors, including at least multiplication, addition, and transformation operations used in the internal computation of a machine learning model.

The term “probability estimation processing” refers to computation that derives probability values or confidence scores for candidate outputs, such as categories or tags, using operations including softmax functions, normalization, or likelihood estimation within a machine learning model.

The term “classification result data” refers to data output from a generative artificial intelligence model or downstream processing that includes at least one candidate category, at least one candidate tag, and associated confidence information.

The term “candidate category” refers to a possible classification label for an item or service that represents a higher-level grouping or class within a taxonomy or classification scheme.

The term “candidate tag” refers to a possible descriptive label for an item or service that represents an attribute, characteristic, or keyword associated with the item or service.

The term “confidence information” refers to data indicating a degree of reliability, probability, or score for each candidate category or candidate tag output by a model.

The term “ranking” refers to processing that orders candidate categories or candidate tags according to confidence information or other criteria.

The term “threshold determination” refers to processing that compares confidence information to a predetermined or dynamically determined threshold value to decide whether a candidate category or candidate tag is to be retained or discarded.

The term “normalization processing” refers to processing that adjusts, maps, or standardizes candidate categories and candidate tags, including at least resolving synonyms, unifying representations, and associating labels with internal identifiers.

The term “internal identifier” refers to a code, index, or key defined within a system for uniquely identifying a category, a tag, an item, or a service in a database or internal data structure.

The term “classification candidate information” refers to structured data that includes at least one candidate category and at least one candidate tag, after ranking, threshold determination, and normalization processing, and that is prepared for presentation to a user.

The term “display function of the user terminal” refers to hardware and software components of a user terminal, such as a display device and graphical user interface software, that present information visually to a user.

The term “selectable candidates” refers to candidate categories or candidate tags that are presented to a user in an interactive manner allowing the user to select, deselect, or modify them through an input operation.

The term “final classification information” refers to classification data, including selected categories and tags, that has been confirmed, corrected, or otherwise determined by a user based on presented classification candidate information.

The term “storage device” refers to a non-transitory computer-readable medium, such as a hard disk drive, a solid-state drive, or a memory device, that stores data including items, services, and associated classification information.

The term “learning history data” refers to data accumulated for training or adjusting a machine learning model, including at least character information, prompt sentences, classification result data, and final classification information confirmed by users.

The term “retrain” refers to processing that updates parameters of a generative artificial intelligence model using additional training data, such as learning history data, to improve model performance.

The term “adjust performance” refers to processing that modifies operation of a generative artificial intelligence model, including at least fine-tuning parameters, changing hyperparameters, or updating inference settings, without necessarily training the model from scratch.

The term “subsequent classification processing” refers to classification operations, including generating new classification candidate information for items or services, that are performed after the generative artificial intelligence model has been retrained or its performance has been adjusted.

The term “response information” refers to information obtained from interactions with a user, including at least explicit inputs, confirmations, corrections, or feedback related to presented classification candidate information.

The term “operation history information” refers to data representing sequences of user actions, such as selections, deselections, edits, and navigation events, performed through a user interface of the user terminal.

The term “instruction content of the prompt sentence” refers to semantic directives contained in a prompt sentence, including what task to perform, what output format to use, and what constraints or conditions apply.

The term “level of detail of the prompt sentence” refers to a degree of specificity or elaboration in a prompt sentence, including how much context, examples, or constraints are described.

The term “output format of the prompt sentence” refers to a specification within a prompt sentence that indicates a desired structure or representation of the model's output, such as a list, a table, or a structured data format.

The term “classification pipeline” refers to a sequence of processing stages executed by a computing system, including text reception, natural language preprocessing, prompt generation, model inference, post-processing, user interaction, and model refinement for classification tasks.

In one embodiment, a server implements the claimed system using a hardware configuration that includes at least one multi-core central processing unit, a main memory, a non-transitory storage device, a network interface controller, and optionally one or more graphics processing units. The server executes a server-side application on an operating system and exposes an application programming interface over a network. The server communicates with at least one terminal operated by a user. The terminal is, for example, a smartphone, a tablet device, or a personal computer, and includes a display device, an input device, and a network communication module.

The server executes an application program composed of multiple functional modules. These modules include at least an input reception module, a natural language preprocessing module, a feature generation module, a prompt generation module, a generative AI inference module, a post-processing module, a feedback registration module, and a model update module. Each module is realized by the processor executing instructions stored in the storage device and loaded in the main memory.

The terminal displays a user interface that allows a user to input character information representing an item or a service. The terminal uses, for example, a web browser rendering a hypertext-based form or a native application rendering a graphical user interface. The user operates the input device of the terminal to enter identification information such as an item name, a short title, or a textual description. The terminal transmits the entered character information to the server using a communication protocol through the network interface.

The server receives the character information from the terminal through the input reception module. The server records the raw character information and associated metadata, such as a time stamp and a user identifier, in the storage device. The server stores this data in a specific data structure, such as a record in an item draft table, where each record includes fields for a character string for a name, a character string for a description, a numerical user identifier, and a numerical shop identifier.

The server uses the natural language preprocessing module to analyze the received character information. In one example implementation, the server executes a natural language processing framework such as a language processing library within a scripting language environment. The server loads a pre-trained language model, and the processor applies tokenization, morphological analysis, phrase segmentation, and part-of-speech tagging to the character strings. The server converts the text into an internal document object that contains, for each token, at least a token index, a lemma, a part-of-speech tag, and dependency information.

The server uses the feature generation module to transform the preprocessed linguistic information into numerical feature data. The server retrieves vector representations for tokens or subword units from an embedding space defined by the loaded language model. The server aggregates these vectors into at least one tensor by applying operations such as concatenation, averaging, or attention-based weighting. The numerical feature data is stored in a structured array representation, where the first dimension corresponds to token positions and the second dimension corresponds to feature dimensions. The server optionally compresses or normalizes these vectors, for example by applying dimensionality reduction or standardization using precomputed parameters. This transformation improves numerical stability and enables efficient execution of subsequent matrix operations in the generative AI inference module.

The server uses the prompt generation module to construct a prompt sentence for a generative AI model. The server maintains a template that contains instruction content, such as a description of a classification task, a specification of an output format, and constraints regarding categories and tags. The server populates placeholders in the template with the actual character information and, optionally, with derived feature summaries. As a result, the server produces a structured natural language instruction that guides the generative AI model to perform classification. An example of such a prompt sentence is:
“Given the following product name and description, generate appropriate categories and tags for an e-commerce system. Use your understanding of the text to infer the most relevant categories and tags. Return the result as a list of category names and tag names.
Product name: Red leather handbag
Description: This is a stylish handbag made of high-quality leather.”

In another example, the server generates a prompt sentence that explicitly specifies a structured output:
“Analyze the following item information and infer the top 5 categories and the top 10 tags. Output the categories and tags in a clear, machine-readable list.
Item name: Wireless noise-cancelling headphones
Item description: Over-ear Bluetooth headphones with active noise cancellation and 30-hour battery life.”

The server uses the generative AI inference module to perform classification based on the prompt sentence and the numerical feature data. In one embodiment, the generative AI model is implemented as a neural network with a sequence-to-sequence architecture, such as a Transformer architecture including an encoder and a decoder. The server stores trained weight parameters of the neural network in the storage device and loads them into memory at runtime. The processor executes operations defined by the neural network, including multi-head self-attention, feedforward layers, layer normalization, and non-linear activation functions. The input to the generative AI model consists of tokenized prompt sequences and, optionally, additional numerical feature vectors that are concatenated or fused into the model's input representation through projection layers.

The server uses an internal tokenizer to convert the prompt sentence into token identifiers according to a predefined vocabulary. The tokenizer may employ subword segmentation techniques, such as byte-pair encoding or wordpiece segmentation, to provide robust tokenization across diverse text. The token identifiers are converted into embedding vectors via a learned embedding matrix. The server then processes these vectors through the encoder and decoder stacks of the Transformer. Throughout this processing, the processor repeatedly executes matrix multiplications, attention score computations, and softmax scaling over the attention weights. The server computes probability distributions over the output vocabulary at each decoding step.

The server configures the generative AI model to generate candidate category and tag names or to directly generate a structured representation indicating categories and tags. To control generation, the server may set parameters such as a temperature value, a top-k threshold, or a top-p sampling parameter. These parameters govern the stochastic sampling process and affect diversity and determinism of outputs. The server receives from the generative AI model either text sequences that encode category and tag names or a representation from which categories and tags can be parsed. The server also obtains internal probability scores associated with each output token or label, which are used as confidence information.

The server uses the post-processing module to interpret and refine the raw outputs from the generative AI model. The server first parses the output text according to a predetermined pattern, extracting candidate category strings and candidate tag strings. The server then normalizes these strings by, for example, transforming them to a standard case, removing leading and trailing whitespace, and mapping synonyms to canonical label forms using a synonym dictionary stored in the storage device. The server further associates each normalized label with an internal identifier defined in a category master table or a tag master table in a relational database. This association converts human-readable labels into compact numerical keys optimized for storage and lookup efficiency.

The server performs ranking of the candidate categories and candidate tags by combining the confidence information obtained from the generative AI model with additional heuristic scores. For example, the server may compute a composite score based on the model's probability for each generated label, a historical acceptance rate for that label from previous user interactions, and a similarity score between the label and high-frequency terms in the current input text. The server uses this composite score to sort candidates in descending order. The server also applies threshold determination by comparing the composite score against a configurable threshold value. Candidates with scores below the threshold are discarded or moved to a low-priority list. This process reduces the number of irrelevant suggestions presented to the user and improves precision of top-ranked categories and tags.

The server constructs classification candidate information as a structured object that contains ordered lists of candidate categories and candidate tags. Each element of these lists includes at least an internal identifier, a display label, and the computed confidence score. The server transmits this classification candidate information to the terminal via the external input/output interface. The terminal receives the information and updates its user interface to present the candidates as selectable elements, such as checkboxes, toggle buttons, or chips. The user can select, deselect, or edit the presented categories and tags using input operations on the terminal.

The server uses the feedback registration module to obtain final classification information from the terminal. The terminal sends the selected and modified categories and tags, in association with the original item or service identifier, back to the server. The server validates the received identifiers against the category and tag master tables and then stores the final classification information as records in association tables, such as an item-category association table and an item-tag association table. The server also stores the final classification information in a learning history table together with the original character information, the prompt sentence, and the classification candidate information generated by the generative AI model. This learning history data is serialized in a structured format with fields for input texts, token sequences, model outputs, user corrections, and time stamps.

The server uses the model update module to improve the generative AI model based on accumulated learning history. In an offline or batch process, the server samples multiple learning history records and constructs training examples. Each example includes input data (character information, derived feature vectors, and corresponding prompt sentences) and target outputs (final categories and tags determined by users). The server defines a loss function, such as a cross-entropy loss over the label space or a sequence-level loss over output tokens, and computes gradients of the loss with respect to the model parameters using backpropagation. The server updates the model parameters using an optimization algorithm, such as stochastic gradient descent with momentum or an adaptive method. The server may perform data augmentation by perturbing input text, injecting noise into embeddings, or altering prompt formulations, thereby increasing robustness of the model to variations in user inputs.

The server periodically or conditionally deploys an updated version of the generative AI model to the generative AI inference module. When a new model version is deployed, the server replaces the previously loaded parameter set with the updated set and reinitializes any associated caches. This dynamic update mechanism allows the system to adapt to changes in vocabulary, taxonomy, and user behavior without manual reprogramming of classification rules. Because the server employs a data-driven learning process instead of fixed, hand-crafted rules, the classification behavior of the system evolves based on actual usage patterns. This difference from traditional rule-based automation constitutes more than simple replication of human decision-making; the system leverages high-dimensional feature representations and gradient-based optimization that are not practically performed by humans.

The described configuration provides several technical effects. Because the server converts raw character information into optimized numerical feature data and prompt sentences tailored to the generative AI model, the subsequent matrix computations in the neural network are more stable and efficient. As a result, the server can perform classification inference with reduced latency and lower computational overhead for each request compared to naive text-to-label mappings. The ranking and thresholding mechanisms implemented by the server reduce the number of low-quality suggestions that must be processed or displayed, which reduces communication bandwidth between the server and the terminal and reduces the rendering workload on the terminal. The adaptive retraining and fine-tuning procedure improves classification accuracy over time, which decreases the number of corrections required from users and reduces unnecessary network traffic caused by repeated update operations.

From the perspective of computer technology, the system improves internal operation of the server by providing a specialized data flow and algorithmic structure for classification tasks. The explicit separation of natural language preprocessing, feature vector generation, prompt construction, neural network inference, and ranking/post-processing enables parallelization and caching strategies. For example, the server may cache feature vectors for frequently used descriptions or reuse normalization mappings for common labels, thereby reducing repeated processing and saving computational resources. The system also improves data management by storing classification outputs in normalized database tables with compact internal identifiers, supporting fast querying and indexing.

The use of a generative AI model with prompt-based control provides a flexible interface between natural language inputs and structured classification outputs. Unlike simple rule-based or linear models that require manual feature engineering and rigid label mappings, the described generative AI model can adapt to new categories and tags by learning from feedback without rewriting procedural code. The specific configuration of the model, including the embedding layers, attention mechanisms, and training procedures, creates a non-conventional pipeline that goes beyond mere automation of human categorization tasks. The model exploits statistical patterns in large volumes of data and uses algorithmic techniques such as backpropagation and gradient descent, which are inherently machine-oriented and not performed by human operators.

In an alternative embodiment, the server employs a different neural network architecture, such as a recurrent neural network with long short-term memory units or a convolutional neural network for text classification, instead of a Transformer-based model. In this case, the server still uses the same data pipeline of natural language preprocessing, feature extraction, prompt generation, inference, and feedback-based retraining. The system can also support multilingual operation by loading different natural language processing models and tokenizers for different languages and by dynamically selecting an appropriate model based on detected language of the character information.

In another embodiment, the server integrates a lightweight generative AI model optimized for edge computation, and the terminal executes part of the preprocessing or post-processing logic locally. For example, the terminal performs tokenization and basic phrase segmentation, while the server executes the heavier neural network inference and ranking operations. This variation reduces bandwidth usage and can further improve overall responsiveness of the system while preserving the same logical flow of classification and feedback.

As described above, the server, the terminal, and the user cooperate to implement a technical configuration in which classification of items and services is performed through a series of specialized computational steps. These steps transform textual input data into numerical feature data, prompt sentences, and structured classification results, and iteratively refine a generative AI model based on user feedback. This configuration improves processing speed, classification accuracy, and resource efficiency of the computing system and therefore constitutes an improvement in the functioning of the computer itself rather than an abstract mental process.

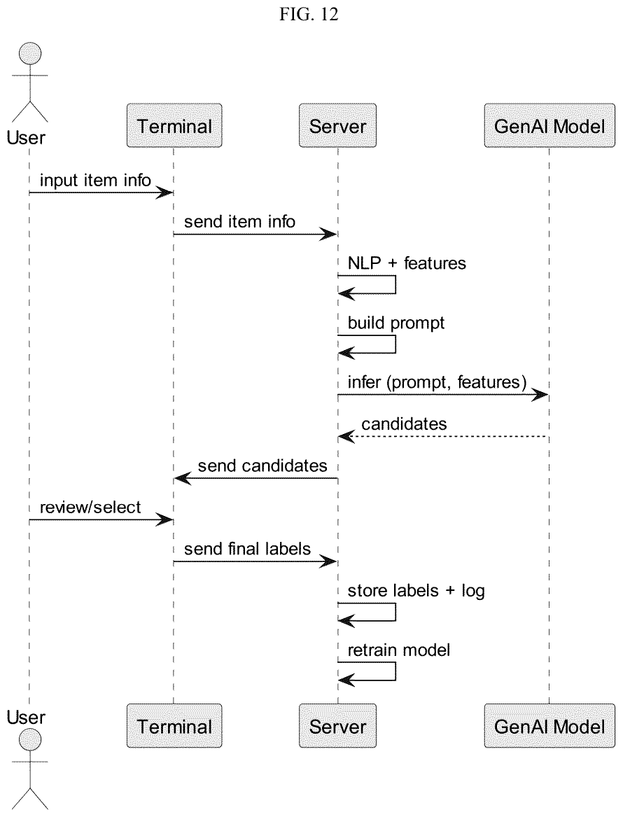

The following describes the processing flow using FIG. 12.

### Step 1:

The terminal displays an item registration screen and receives identification information from the user.

The terminal renders input fields for at least an item name and an item description using a browser or a native application. The user operates an input device to type character strings, such as a product name and a descriptive sentence.
Input: raw keystrokes and touch events from the user.

The terminal converts these user actions into text values, performs basic validation (for example, non-empty checks and maximum length checks), and constructs a request payload containing the item name and description.
Output: a structured data object (for example, a JSON payload) including the item name, description, and user identifier, ready for transmission to the server.

### Step 2:

The terminal transmits the structured character information to the server.

The terminal opens a network connection and sends an HTTP or HTTPS request to an endpoint exposed by the server. The terminal attaches the structured payload in the body of the request and sets appropriate headers to indicate the data format.
Input: the structured data object generated in Step 1.

The terminal serializes the object into a byte stream and hands it to a network communication module, which encapsulates it into packets and transmits it over the network.
Output: a network message containing the character information that arrives at the server's network interface.

### Step 3:

The server receives the network message and stores the raw character information.

The server accepts the incoming HTTP or HTTPS request via a network interface controller and passes the byte stream to a web application framework. The server parses the request body to reconstruct the item name, description, and user identifier.
Input: the received network message including serialized character information.

The server decodes the byte stream, extracts the text fields, and writes them into a persistent store, such as a record in an item draft table. The server also attaches metadata including a time stamp and a session identifier.
Output: a stored record in the server's data storage, containing raw character information and metadata.

### Step 4:

The server performs natural language preprocessing on the character information.

The server retrieves the stored item name and description and concatenates them into a single text string or a pair of text fields. The server invokes a natural language processing library and loads an appropriate language model.
Input: the raw character strings (item name and description) from the stored record.

The server tokenizes the text into tokens, assigns part-of-speech tags, applies morphological analysis to derive lemmas, and segments the text into phrases. The server then constructs an internal document representation that associates each token with indices, tags, and dependency relations.
Output: a preprocessed text representation containing tokens, linguistic annotations, and phrase boundaries.

### Step 5:

The server generates numerical feature data from the preprocessed text.

The server uses embedding functions or word vector models to convert each token into a numerical vector in a continuous feature space.
Input: the preprocessed text representation produced in Step 4.

The server maps each token to an embedding vector, stacks these vectors into a matrix, and optionally applies normalization or dimensionality reduction. The server may aggregate token vectors into sentence-level or document-level feature vectors by averaging or applying attention-based weighting.
Output: numerical feature data in the form of one or more tensors that encode the semantic content of the item name and description.

### Step 6:

The server constructs a prompt sentence for the generative AI model.

The server accesses a prompt template that defines instructions, desired output format, and contextual information. The server inserts the actual item name and description into placeholder positions in the template.
Input: the raw character strings (item name and description) and, optionally, summaries derived from the numerical feature data.

The server concatenates fixed instruction text with the user's item information to build a complete natural language instruction. For example, the server may produce a prompt sentence such as:
“Given the following product name and description, generate appropriate categories and tags for an e-commerce system. Use your understanding of the text to infer the most relevant categories and tags. Return the result as a list of category names and tag names.
Product name: Red leather handbag
Description: This is a stylish handbag made of high-quality leather.”

The server stores this prompt string in association with the item record for traceability.
Output: a fully formed prompt sentence ready to be tokenized and fed into the generative AI model.

### Step 7:

The server encodes the prompt sentence and prepares model input.

The server invokes a tokenizer compatible with the generative AI model and converts the prompt sentence into a sequence of token identifiers.
Input: the prompt sentence from Step 6 and the numerical feature data from Step 5.

The server maps each token identifier to an embedding vector via an embedding matrix defined in the model configuration. The server optionally combines or concatenates the prompt embeddings with the numerical feature data (for example, by projecting feature vectors into the same dimensional space and appending them to the input sequence).
Output: a set of model input tensors, including token embeddings and optional auxiliary feature tensors, arranged in the format required by the generative AI model.

### Step 8:

The server executes inference using the generative AI model.

The server loads the generative AI model parameters into memory and initializes the neural network layers, such as attention blocks and feedforward networks.
Input: the model input tensors generated in Step 7.

The server performs forward propagation through the network: it computes attention weights, applies matrix multiplications in each layer, adds bias terms, applies non-linear activation functions, and normalizes intermediate representations. The server calculates output logits over the label or token space and converts these logits into probability distributions using softmax operations. Depending on configuration, the server either decodes a sequence of tokens representing category and tag names or directly computes probabilities for a set of predefined labels.
Output: raw model output data, including generated token sequences and probability scores associated with categories and tags.

### Step 9:

The server derives candidate categories and tags with confidence information.

The server parses the raw model output to extract category and tag labels. When the generative AI model outputs text, the server splits the text into individual labels using delimiters and patterns; when the model outputs label indices, the server maps those indices back to label names.
Input: the raw model output data from Step 8.

The server associates each label with a confidence value derived from the probability scores of the model. The server then normalizes these labels by applying string normalization and mapping synonyms to canonical names. The server looks up each canonical label in a database to obtain an internal identifier.
Output: a structured list of candidate categories and candidate tags, each element containing a label name, an internal identifier, and a confidence score.

### Step 10:

The server ranks and filters the candidate categories and tags.

The server computes a composite score for each candidate based on the model's confidence score and, optionally, historical acceptance statistics stored from previous user interactions.
Input: the structured list of candidates from Step 9 and historical metrics retrieved from the database.

The server sorts the candidates in descending order of composite score and compares each score to a predefined or dynamically calculated threshold. The server discards or marks as low-priority any candidates whose scores fall below the threshold.
Output: a refined and ordered set of classification candidate information containing top-ranked categories and tags suitable for presentation to the user.

### Step 11:

The server transmits classification candidate information to the terminal.

The server constructs a response message that includes the refined candidate categories and tags, with their display names and internal identifiers.
Input: the refined and ordered classification candidate information from Step 10.

The server serializes this information into a structured format and sends it as an HTTP or HTTPS response to the terminal through the network interface.
Output: a network response message conveying the classification candidate information to the terminal.

### Step 12:

The terminal receives and displays the classification candidate information.

The terminal parses the server's response and reconstructs the list of candidate categories and tags.
Input: the network response message containing classification candidate information from

### Step 11.

The terminal generates user interface elements corresponding to each candidate, such as checkboxes or selection chips. The terminal arranges these elements in the item registration screen so that the user can easily view and modify them.
Output: a rendered user interface displaying the suggested categories and tags as selectable options.

### Step 13:

The user reviews and edits the suggested categories and tags.

The user visually inspects the suggested candidates on the terminal's display. The user may select relevant categories, deselect irrelevant ones, and, if permitted, add new categories or tags through additional input fields.
Input: the displayed candidate categories and tags presented by the terminal in Step 12.

The user interacts with the terminal's input devices, and the terminal records selection states and newly entered labels. The terminal updates its internal representation of the current classification choices in real time as the user modifies them.
Output: a final selection set of categories and tags within the terminal, including any user-defined additions or corrections.

### Step 14:

The terminal transmits the final classification information to the server.

The terminal collects the user's final selections and composes a structured payload containing the chosen category identifiers, tag identifiers, and any newly added labels, together with the original item identifier.
Input: the final selection set maintained within the terminal after user interaction in Step 13.

The terminal serializes this payload and sends it to the server via an HTTP or HTTPS request targeted at a registration or update endpoint.
Output: a network message carrying final classification information that reaches the server.

### Step 15:

The server validates and stores the final classification information.

The server parses the incoming request and retrieves the item identifier and the selected category and tag identifiers.
Input: the network message containing final classification information from Step 14.

The server checks that each identifier exists in the category and tag master tables, ensures referential integrity, and then writes records into association tables linking the item with the confirmed categories and tags. The server also stores any newly created labels in the master tables and assigns new internal identifiers.
Output: persistent database records that represent the final classification of the item and updated master tables reflecting any new labels.

### Step 16:

The server registers learning history data for model improvement.

The server compiles a learning history entry that includes the original character information, the prompt sentence, the candidate categories and tags generated by the generative AI model, and the final classification information confirmed by the user.
Input: the raw character information and prompt sentence from earlier steps, the candidate information from Step 10, and the final classification information from Step 15.

The server serializes these components into a training example format and inserts the example into a learning history repository. The server indexes the entry by time, item type, and user identifier to support efficient sampling for training.
Output: stored learning history records that can be retrieved later for retraining or fine-tuning the generative AI model.

### Step 17:

The server updates the generative AI model based on accumulated learning history.

The server periodically retrieves multiple learning history records and constructs training batches.
Input: a set of learning history records from Step 16.

The server feeds the input portions (character information, derived features, and prompt sentences) into the generative AI model and compares the model's predicted labels with the user-confirmed labels. The server computes a loss value using a predefined loss function and calculates gradients via backpropagation. The server updates the model weights using an optimization algorithm and saves the updated weights in the storage device for future inference.
Output: an updated set of model parameters that reflects user feedback and improves classification accuracy in subsequent runs.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional category and tag suggestion systems that rely directly on a generative AI model to classify user-provided text suffer from several technical deficiencies in terms of computer technology. First, such systems often construct prompt sentences in an ad hoc, heuristic manner without leveraging structured similarity analysis between the input text and reference records stored in a database. As a result, the generative AI model is frequently invoked with noisy, unweighted, or context-poor input, which leads to unstable and inconsistent outputs. This instability forces repeated model calls and additional post-processing on the server, thereby increasing processor load, network traffic, and latency.

Second, existing systems generally do not combine deterministic similarity computation based on numerical vector representations with the probabilistic reasoning of a generative AI model in a coordinated pipeline. Without a prior, data-driven narrowing of relevant categories and tags via similarity scores, the generative AI model must search an excessively broad output space. This degrades the efficiency of model utilization, increases token consumption, and can reduce precision, such that the server resources and memory bandwidth are not used optimally.

Third, typical implementations do not impose machine-readable output constraints on the responses from the generative AI model. When the model returns unstructured natural language, the server must perform costly and error-prone parsing to extract categories and tags, which increases CPU cycles, error handling complexity, and failure modes. This can result in additional database queries and retries, further degrading overall throughput of the system.

Fourth, many systems do not adapt the behavior of the prompt sentence to a user's state inferred from input text and operation history. Without such adaptation, the same prompt design is used regardless of whether the user is expert or novice, or whether the input is detailed or terse. This lack of dynamic prompt control prevents optimization of the balance between model guidance and autonomy, and can cause either under-specification (leading to vague outputs) or over-specification (leading to unnecessarily long or complex outputs), both of which waste computational resources on the server and on the generative AI model side.

Accordingly, there is a need for a technical framework in which a server: (i) preprocesses user input text into normalized token sets; (ii) performs numerical similarity computation against reference data to derive primary candidate categories and tags; (iii) embeds these primary candidates into a structured prompt sentence for a generative AI model; (iv) constrains the model output to a machine-readable array format; and (v) dynamically adjusts the prompt content based on an estimated user state. Such a framework should improve the efficiency, stability, and accuracy of category and tag suggestion processing, reduce unnecessary computational and network overhead, and enhance the overall performance of the computer system implementing the classification pipeline.

The specific processing by the specific processing unit 290 of the data processing device 12 in Example 2 is realized by the following means.

The present invention provides a server comprising a processor and a memory storing instructions which, when executed by the processor, cause the processor to receive character information from a user terminal, to perform language preprocessing on the character information using a language processing program to generate normalized character strings, to compute similarity indices between the normalized character strings and reference information stored in a storage apparatus using numerical similarity techniques, to aggregate and weight classification information and additional information associated with candidate records selected based on the similarity indices so as to estimate primary classification information and primary additional information, to construct a prompt sentence that includes at least the primary classification information, the primary additional information, and the character information and that is formatted as an input to a generative information processing model, to input the prompt sentence into the generative information processing model and analyze a machine-readable response to determine confirmed classification information and confirmed additional information, to provide the confirmed classification information and the confirmed additional information to the user terminal for optional user correction, and to store final classification information and final additional information in the storage apparatus. This enables the server to offload part of the classification decision to deterministic similarity computation before invoking the generative model, to constrain the generative model's operation to a narrower, data-driven hypothesis space, to obtain structured and machine-readable outputs that require minimal parsing, and to thereby improve processing efficiency, response stability, and resource utilization of the computer system implementing automated category and tag suggestion.

The term “processor” refers to a hardware information processing unit, such as a central processing unit or a processing core, that executes instructions to perform computational and control operations of the system.

The term “memory” refers to a hardware storage component, such as volatile memory or non-volatile memory, that stores instructions and data to be accessed and executed by the processor.

The term “instructions” refers to machine-readable commands or program code segments that, when executed by the processor, cause the processor to perform specified computational, logical, or control operations.

The term “user terminal” refers to an information processing device operated by a user, such as a portable terminal, a stationary terminal, or a display-equipped communication device, that transmits character information to the server and receives presentation data from the server.

The term “character information” refers to text-based data, including but not limited to symbols, letters, numerals, and punctuation, that is input by a user and processed by the system for classification or tagging.

The term “language processing program” refers to executable software, including natural language processing modules, that performs operations such as tokenization, normalization, stop-word removal, and lemmatization on character information.

The term “normalized character strings” refers to character sequences obtained after applying preprocessing operations, including at least tokenization, removal of unnecessary terms, and standardization of textual forms, to the received character information.

The term “information storage apparatus” refers to a hardware storage system, such as a database apparatus or a file storage apparatus, that stores reference information, classification information, and additional information used by the system.

The term “reference information” refers to previously stored data records in the information storage apparatus, each record being associated with one or more pieces of classification information and additional information, and used as a basis for similarity computation.

The term “occurrence frequency information” refers to numerical data representing how frequently particular character strings appear within reference information or character information, including but not limited to term frequency values or term frequency-inverse document frequency values.

The term “distributed representations” refers to numerical vector representations of character strings, sentences, or documents in a multidimensional space, obtained by training or applying a statistical model or machine learning model.

The term “similarity computation” refers to a numerical operation that calculates a similarity index between the normalized character strings and the reference information by using occurrence frequency information, distributed representations, or other numerical features.

The term “similarity index” refers to a numerical value that quantitatively indicates a degree of similarity between the normalized character strings and a particular item of reference information.

The term “candidate information” refers to a subset of the reference information selected based on the similarity index, the subset including records deemed relevant to the received character information.

The term “classification information” refers to data representing categories, labels, or classes assigned to reference information or to the received character information.

The term “additional information” refers to data associated with reference information or the received character information, other than classification information, including but not limited to tags, attributes, descriptors, or keywords.

The term “primary classification information” refers to preliminary classification information for the received character information, estimated by aggregating and weighting classification information associated with candidate information based on the similarity index.

The term “primary additional information” refers to preliminary additional information for the received character information, estimated by aggregating and weighting additional information associated with candidate information based on the similarity index.

The term “explanatory character string” refers to a text sequence constructed to include at least the received character information, the primary classification information, and the primary additional information, and used as a basis for generating a prompt sentence.

The term “prompt sentence” refers to a text-based instruction, derived from the explanatory character string and formatted according to an input specification of a generative information processing model, that guides the generative information processing model to produce a response.

The term “generative information processing model” refers to a trained computational model, such as a generative artificial intelligence model, that receives the prompt sentence as input and outputs a response character string including classification information and additional information.

The term “response character string” refers to text data output from the generative information processing model in response to the prompt sentence, the text data including candidate classification information, additional information, or both.

The term “confirmed classification information” refers to classification information determined by verifying and updating the primary classification information based on analysis of the response character string.

The term “confirmed additional information” refers to additional information determined by verifying and updating the primary additional information based on analysis of the response character string.

The term “presentation data” refers to data formatted for display on the user terminal, including at least the confirmed classification information and the confirmed additional information, that allows a user to review or modify the suggested results.

The term “confirmation input” refers to input data received from the user terminal indicating that a user has approved the presented confirmed classification information and confirmed additional information.

The term “correction input” refers to input data received from the user terminal indicating that a user has modified, added, or removed part of the presented confirmed classification information or confirmed additional information.

The term “final classification information” refers to classification information that is stored in the information storage apparatus after incorporating at least one of the confirmation input and the correction input.

The term “final additional information” refers to additional information that is stored in the information storage apparatus after incorporating at least one of the confirmation input and the correction input.

The term “machine-readable array representation” refers to a structured data format, such as a list or array notation, that can be automatically parsed by the processor to identify individual elements of classification information and additional information.

The term “structured data” refers to data organized according to a predetermined format, such as a machine-readable array representation or a record structure, that allows deterministic parsing and extraction by the processor.

The term “user state” refers to an estimated condition or characteristic of a user, inferred from at least one of the character information and an operation history, such as expertise level, intent, or interaction pattern.

The term “operation history” refers to data representing past actions performed via the user terminal, including but not limited to input frequency, editing behavior, selection behavior, and interaction sequences.

In one embodiment, a server cooperates with a terminal operated by a user to implement the claimed system. The server includes at least one processor and at least one memory device. The processor executes a set of software modules including a web application module, a natural language processing module, a similarity computation module, a generative AI interface module, and a data storage management module. The memory stores configuration parameters, trained machine learning models, vector representations, and reference records including categories and tags.

The server is implemented on a general-purpose computing platform, for example a rack-mount server or a virtual machine running on a cloud computing infrastructure. The server runs an operating system such as a generic server operating system and hosts an application framework such as a generic web framework that exposes a network API. The terminal is implemented by a client device, such as a smartphone, a tablet, or a personal computer, that runs a web browser or a dedicated application program. The user interacts with the terminal via a graphical user interface to input text and to review and edit proposed categories and tags.

The server receives character information from the terminal in the form of user-provided text describing an entity such as a store, a product, or a service. The terminal converts the user's input into a structured message and transmits the message to the server via a communication network using a network protocol. The server parses the received message, extracts one or more text fields, and concatenates them into a single character string for further processing. The server stores the raw character string in the memory together with a unique request identifier.

The server applies a language processing program to the character string in order to generate normalized character strings. In one example, the server employs a natural language processing library of the type generally known as a statistical text analysis toolkit. The server loads a pre-trained pipeline for a target language and applies a sequence of operations including tokenization, part-of-speech tagging, lemmatization, stop-word removal, and lowercasing. The server removes punctuation symbols and numbers that do not contribute to semantic classification and normalizes spelling variants. The server thereby generates a list of tokens that are represented as normalized character strings and stores this list as an intermediate data structure in the memory, for example as an array of string objects.

The server converts the normalized character strings into one or more numerical feature vectors. In one embodiment, the server uses a term frequency-inverse document frequency (TF-IDF) model created by a machine learning library of the type generally known as a scientific computing toolkit for vectors and matrices. The server maintains a vocabulary index mapping tokens to dimensions in a sparse vector space. The server computes TF-IDF values for the tokens and assembles them into a sparse vector. In another embodiment, the server also generates distributed representations, such as word embeddings or sentence embeddings, by using a neural network-based encoder. In this case, the server feeds the normalized character strings into a trained embedding model based on a neural network architecture, for example a transformer encoder that includes multiple self-attention layers, feedforward layers, and normalization layers. The server obtains a fixed-dimensional dense vector that represents semantic information about the input text.

The server performs similarity computation between the feature vectors for the input character information and feature vectors for reference information stored in an information storage apparatus. The server stores reference records in a relational database or other structured storage, where each record is associated with at least one precomputed feature vector and associated classification information and additional information. The server loads, from the storage apparatus, a set of precomputed TF-IDF vectors and embedding vectors, and arranges them into matrices in memory. The server computes similarity indices, for example cosine similarity, between the input vectors and the reference vectors using vector algebra routines that operate on the matrices. The server thereby calculates a numerical similarity index for each reference record.

The server selects candidate information by ranking the similarity indices and choosing a subset of reference records whose similarity indices exceed a threshold or fall within a top-N ranking. The server retrieves classification information and additional information, such as tags and descriptors, associated with each selected record. The server uses data structures such as hash maps and counting arrays to aggregate these classification and additional information items. The server multiplies contribution values for each item by a weight derived from the similarity index of the corresponding record, for example by computing a weighted sum where the weight is a monotonic function of the similarity index. The server thereby estimates primary classification information and primary additional information that represent a deterministic, data-driven preliminary classification of the input character information.

The server constructs an explanatory character string that concatenates the input description and the primary classification information and primary additional information. The server forms this explanatory string in a controlled format that is designed to be consumed efficiently by a generative AI model. The server then generates a prompt sentence by embedding explicit instructions about the task, the context, and the desired output format. For example, the server can construct a prompt sentence of the following form:
“We received the following store information: store name: ‘Café de Monde’; description: ‘A cafe offering French-style baked sweets and coffee.’ Based on internal similarity search, we inferred these tags: [Cafe, French, Baked goods, Coffee]. As a generative AI model, please check whether these tags are appropriate and add any important missing tags. Return the final tags only as a JSON-like array of strings, such as [‘tag1’, ‘tag2’, ‘tag3’].”

The server formats the prompt sentence as an input sequence represented in a tokenized form that is compatible with the interface of a generative information processing model. In one embodiment, the server communicates with an external generative AI service that hosts a transformer-based language model. Such a model can include an encoder-decoder or decoder-only architecture with multiple layers, each layer including multi-head self-attention, feedforward networks, and positional encoding. The model is trained on large text corpora using a loss function such as cross-entropy loss, and its parameters are updated by gradient descent-based optimization, for example using an adaptive gradient optimizer. The model is fine-tuned for instruction-following behavior by supervised learning and optionally by reinforcement learning from human feedback, where policy gradients or similar techniques adjust model parameters based on reward signals.

The server sends the prompt sentence to the generative AI model by packaging the tokenized representation into a request message and issuing the request through a network interface.

The server specifies model parameters such as maximum output length, temperature, and response format preference. The server receives a response character string from the generative AI model, where the response character string is expected to contain classification information and additional information formatted as a machine-readable array representation or a clearly delimited list. The server analyzes the response character string by applying syntactic parsing rules or regular expressions, or by using a simple parser that expects a bracketed list of quoted strings. The server extracts candidate tags and categories, cleans them by trimming whitespace and normalizing case, and removes duplicates and invalid entries according to predefined rules.

The server compares the response-derived items with the primary classification information and primary additional information, and determines confirmed classification information and confirmed additional information. The server can maintain a consistency rule set in memory that specifies, for example, that items below a certain similarity-based confidence threshold are discarded, or that items not present in a controlled vocabulary are tagged as custom items.

The server assigns scores to the items and selects a final set of confirmed items for presentation. Because the server supplies the generative model with pre-filtered, similarity-based candidates and explicit output-format constraints in the prompt sentence, the server can reduce unnecessary diversity in the model's responses and thereby improve determinism and reliability. This improves the computer's efficiency in parsing outputs and reduces repeated calls to the model.

The server transmits the confirmed classification information and confirmed additional information to the terminal as presentation data. The terminal displays the presented items in a graphical layout that allows the user to confirm, delete, or add items. The user inspects the proposed categories and tags and, if needed, edits them. The terminal sends a confirmation input or a correction input back to the server, including the final list of classification information and additional information chosen by the user. The server receives this input, stores the final classification information and final additional information in the information storage apparatus, and optionally updates statistics used for retraining or adjusting the similarity computation models.

In another embodiment, the server estimates a user state based on characteristics of the input text or on an operation history from the terminal. For example, the server extracts features such as average input length, frequency of manual overrides of suggested tags, and time to complete previous tasks. The server uses a lightweight classifier, such as a logistic regression or a small neural network, to estimate a user state category such as “novice,” “intermediate,” or “expert.” The server then adapts the prompt sentence according to the estimated user state.

For a novice user, the server includes more detailed instructions and allows the generative AI model to suggest a broader set of tags. For an expert user, the server tightens the output constraints and emphasizes adherence to the primary classification information. This dynamic prompt control reduces over-specification for expert users and under-specification for novice users, improving computational efficiency by tailoring the generative AI model's search space to the user context.

The server thereby improves computer technology in several concrete ways. By performing deterministic similarity computation using TF-IDF vectors and distributed representations prior to invoking the generative AI model, the server reduces the size of the hypothesis space that the generative model must explore, which decreases average token usage and network traffic per request. This leads to faster response times and reduces CPU and memory usage in both the server and the external AI service. By constraining the generative model's output format to a machine-readable array representation and designing prompt sentences that explicitly request such a format, the server minimizes parsing complexity and avoids fragile natural-language post-processing. This reduces parsing errors and eliminates repeated correction cycles, thereby improving throughput.

The server's use of structured intermediate data, including normalized token arrays, vector embeddings, similarity matrices, and weighted aggregation tables, allows the system to apply non-conventional computational steps that are not simple automation of human judgment. A human operator does not naturally compute high-dimensional cosine similarity indices or dynamically adjust a neural language model's behavior based on distributional vector space statistics. The server implements such operations using numerical linear algebra and optimization techniques, which exploit the hardware capabilities of the processor and memory hierarchies. The combination of deterministic similarity computation and probabilistic generative modeling results in higher classification precision and lower variance than either approach alone, as the deterministic stage filters out irrelevant candidates and the generative stage refines results using learned language patterns.

In yet another embodiment, the server locally hosts the generative information processing model instead of accessing an external service. In this configuration, the server loads a trained neural network model into memory and performs inference directly on its processor or on an attached accelerator, such as a graphics processing unit or a tensor processing unit.

The server uses a matrix multiplication library optimized for the target hardware to compute attention scores and layer outputs in the neural network. The server optionally quantizes model weights to reduce memory bandwidth and latency, which further improves processing speed. The server may periodically retrain or fine-tune the generative model using stored final classification information and additional information in an offline mode. During retraining, the server computes a loss function measuring the difference between predicted tags and stored final tags and updates the model parameters using gradient descent and backpropagation. The server can also apply data augmentation by slightly perturbing input texts or by mixing multiple descriptions to improve robustness.

Alternative embodiments can use different similarity metrics, such as dot product similarity or distance-based metrics, and can employ alternative neural architectures, such as convolutional networks or recurrent networks, to generate distributed representations. The server can also select different weighting schemes for aggregating classification information, such as logarithmic scaling of similarity indices, or can use graph-based propagation if reference information is structured as a graph. The system can be applied to various domains, including classification of documents, media files, or sensor logs. In each case, the server uses the same technical pattern: normalization of input data, numerical similarity computation, structured prompt construction, controlled generative model interaction, and machine-readable response analysis.

Because the server coordinates these modules in a specific non-conventional pipeline and uses explicit prompt sentence design combined with similarity-based pre-filtering, the system reduces communication load, decreases CPU time for repeated model invocations, and improves accuracy of suggested categories and tags. The technical effect arises from the particular data structures and algorithms applied in combination: normalized token arrays enable high-quality vectorization; vectorization feeds into similarity matrices; similarity matrices drive weighted aggregation; aggregated results constrain the prompt sentence; and constrained prompts yield more deterministic, machine-readable outputs that are easier to parse and store. This chain of operations improves the functioning of the computer as a classification engine and provides a concrete enhancement over systems that rely solely on heuristic prompts or purely rule-based classification.

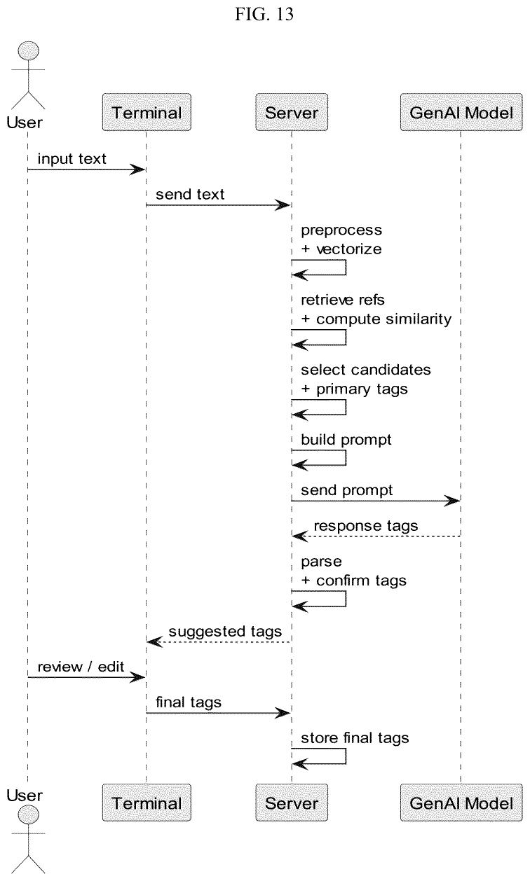

The following describes the processing flow using FIG. 13.

### Step 1:

The user operates the terminal to input character information. The user opens an application on the terminal and types at least one of a name and a description into text input fields. The terminal receives the keystrokes, constructs text strings such as a store name and a store description, and combines them into a single character information object.
Input: raw keystrokes and UI events from the user.
Processing: the terminal converts the UI events into text strings, checks for empty fields or excessive length, and packages the strings into an internal data structure.
Output: a structured request payload including character information to be sent to the server.

### Step 2:

The terminal transmits the character information to the server. The terminal converts the internal data structure into a network message, for example an HTTP request body, and sends it over a communication network.
Input: structured request payload containing character information.
Processing: the terminal serializes the payload into a text-based message, attaches headers such as an endpoint path and content type, and opens a network connection to the server.
Output: a network request containing the character information, delivered to the server.

### Step 3:

The server receives and parses the character information. The server accepts the network request, extracts the message body, and decodes the character information.
Input: network request containing serialized character information.
Processing: the server validates headers, reads the request body, parses the serialized text into fields such as “name” and “description,” concatenates the fields into a single character string, and assigns a unique request identifier.
Output: a raw character string and associated metadata stored in server memory.

### Step 4:

The server performs language preprocessing to generate normalized character strings. The server applies a language processing program to the raw character string.
Input: raw character string and language processing configuration.
Processing: the server tokenizes the string into word units, converts characters to a standard case, removes punctuation and predefined stop words, and applies lemmatization to reduce inflected forms to base forms. The server organizes the remaining tokens into an ordered list.
Output: an array of normalized tokens representing normalized character strings.

### Step 5:

The server converts the normalized tokens into numerical feature vectors. The server uses a feature extraction model to encode the normalized tokens.
Input: array of normalized tokens.
Processing: the server maps each token to an index in a vocabulary, computes term frequency and inverse document frequency values, and assembles a sparse TF-IDF vector. In parallel or alternatively, the server feeds the tokens into an embedding model and aggregates token embeddings into a dense vector representing the entire text.
Output: one or more numerical feature vectors representing the semantic content of the character information.

### Step 6:

The server retrieves reference information and associated vectors from an information storage apparatus. The server prepares comparison data for similarity computation.
Input: request identifier and configuration specifying which reference dataset to use.
Processing: the server issues queries to a database to load precomputed feature vectors and associated records containing categories and tags, and then arranges these vectors into matrix structures in memory.
Output: a set of reference records and corresponding feature vector matrices available in server memory.

### Step 7:

The server computes similarity indices between the input feature vectors and the reference vectors.
Input: input feature vectors and reference vector matrices.
Processing: the server applies a similarity function, such as cosine similarity, to compute a similarity index for each pair of input vector and reference vector. The server executes matrix-vector operations to obtain a similarity score list.
Output: a list of similarity indices associated with respective reference records.

### Step 8:

The server selects candidate information based on the similarity indices.
Input: list of similarity indices and reference records.
Processing: the server sorts the records by similarity index, discards records whose indices fall below a configured threshold, and selects a top subset. The server extracts classification information and additional information, such as categories and tags, from these selected records.
Output: a candidate set of records including associated categories and tags.

### Step 9:

The server aggregates and weights classification information and additional information to estimate primary items.
Input: candidate set of records and corresponding similarity indices.
Processing: the server counts occurrences of each category and tag across the candidates and multiplies the counts by a weight derived from each record's similarity index. The server sums the weighted counts, normalizes the scores if necessary, and ranks categories and tags by their aggregate scores.
Output: primary classification information and primary additional information ranked by importance.

### Step 10:

The server constructs an explanatory character string and generates a prompt sentence for a generative AI model.
Input: raw character string, primary classification information, and primary additional information.
Processing: the server embeds the input description and the primary items into a formatted explanation, and appends explicit instructions for the desired output format. The server then generates a prompt sentence, for example:
“We received the following store information: store name: ‘Café de Monde’; description: ‘A cafe offering French-style baked sweets and coffee.’ Based on internal similarity search, we inferred these tags: [Cafe, French, Baked goods, Coffee]. As a generative AI model, please check whether these tags are appropriate and add any important missing tags. Return the final tags only as an array of strings, such as [‘tag1’, ‘tag2’, ‘tag3’].”
Output: a prompt sentence string ready to be sent to the generative AI model.

### Step 11:

The server sends the prompt sentence to a generative AI model and receives a response character string.
Input: prompt sentence and model configuration parameters.
Processing: the server tokenizes the prompt sentence, constructs a model input request, and transmits it to an internal or external generative AI model via a model interface. The model performs neural network inference and returns a generated text output. The server receives the output and decodes it into a response character string.
Output: a response character string containing proposed categories and tags in a structured or semi-structured format.

### Step 12:

The server parses the response character string and determines confirmed classification information and confirmed additional information.
Input: response character string and parsing rules.
Processing: the server applies parsing logic to extract individual items, such as category names and tag names, from the response. The server normalizes the extracted items, resolves duplicates, and compares them with the primary items. The server applies decision rules to accept, modify, or discard items and thereby finalizes a set of confirmed categories and tags.
Output: confirmed classification information and confirmed additional information suitable for presentation to the user.

### Step 13:

The server transmits the confirmed classification information and confirmed additional information to the terminal as presentation data.
Input: confirmed classification information and confirmed additional information.
Processing: the server packages the confirmed items into a response message, associates the message with the original request identifier, and sends the message to the terminal via the communication network.
Output: a presentation response delivered to the terminal containing suggested categories and tags.

### Step 14:

The terminal displays the suggested categories and tags and receives user feedback.
Input: presentation response from the server.
Processing: the terminal parses the response, renders the confirmed classification information and additional information as selectable items on a user interface, and accepts operations such as selection, deletion, and addition from the user. The user reviews the suggestions, modifies them if necessary, and triggers a confirmation action.
Output: a feedback payload from the terminal containing confirmation input and, optionally, correction input.

### Step 15:

The server stores final classification information and final additional information based on the user feedback.
Input: feedback payload including confirmation input and correction input.
Processing: the server merges user modifications with the confirmed items, produces final categories and tags, and writes them into the information storage apparatus as part of a persistent record associated with the original character information. The server may also update training or statistics tables used in future similarity computations or model tuning.
Output: stored final classification information and final additional information committed to the storage apparatus.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information classification systems that use machine learning or rule-based processing typically map user-provided text or images directly to fixed categories or tags. Such systems often suffer from several technical limitations. First, when the system relies only on raw input features without structured prompt generation, interaction with a generative AI model can be inefficient and unstable: the same input content may yield inconsistent classification outputs due to unstructured or suboptimal prompts, leading to unpredictable behavior of the underlying inference pipeline. Second, these systems generally do not unify heterogeneous input modalities, such as image information and character information, into a coherent representation before downstream processing, which can result in under-utilization of available data and reduced accuracy in content classification and identification. Third, user emotion is rarely modeled as a first-class computational signal; consequently, the system cannot adjust the internal inference conditions or outputs based on emotion states, and cannot dynamically tune the behavior of the generative model to the user's current context. Fourth, conventional systems usually lack a feedback-based learning mechanism that closes the loop between user selections (or corrections) and future prompt generation or output ordering. As a result, processing pipelines cannot adapt to real user behavior over time, causing persistent inefficiencies and degraded relevance of suggested categories and tags.

More specifically, in architectures where a processor simply forwards input text or image-derived labels to a generative AI model, the processor does not appropriately structure the input as a prompt sentence tailored to the model's strengths and limitations. This can increase the computational cost on the model side, require repeated calls to refine results, and may demand additional post-processing to filter noisy outputs. Furthermore, when classification and identification information are proposed without considering user emotion, the system may generate technically correct but context-insensitive suggestions, increasing the number of user edits and round trips between the user terminal and the server, and thereby increasing latency and server load. In addition, because user-confirmed labels and corrections are not effectively accumulated as structured stored information, the system cannot automatically adjust ranking or selection of candidate categories and tags, which leads to repeated computation of low-value suggestions and redundant use of computational resources.

Accordingly, there is a need for a technical mechanism in which a processor systematically (i) extracts attribute information from heterogeneous inputs using image processing and natural language processing, (ii) composes optimized prompt sentences for a generative AI model, (iii) incorporates emotion information into prompt generation and output adjustment, and (iv) uses stored interaction histories to adapt prompt generation and output ordering. By introducing such mechanisms, it becomes possible to improve the consistency, efficiency, and accuracy of classification and identification processing executed by a computer system, thereby providing a concrete improvement to computer-implemented information processing rather than merely automating a human cognitive task.

The specific processing by the specific processing unit 290 of the data processing device 12 in Application Example 2 is realized by the following means.

The present invention provides a server comprising a processor configured to receive, from a user terminal, image information or character information regarding a target object to be processed; to extract attribute information regarding the target object by applying image processing to the image information, or to extract attribute information regarding the target object by applying natural language processing to the character information; to generate, based on the extracted attribute information and emotion information indicating an emotional state of a user, a prompt sentence including an instruction statement for classifying the target object, for input to a generative AI model; to input the prompt sentence to the generative AI model and generate classification information or identification information related to the target object based on response information obtained from the generative AI model; to transmit the classification information or the identification information to the user terminal, to update the classification information or the identification information in accordance with selection or correction input from the user, and to store an update result in association with stored information; and to adjust, by learning, generation of the prompt sentence or an output order of the classification information or the identification information based on the stored information. This enables the server to improve the technical behavior of the classification pipeline itself by optimizing prompt sentences for the generative AI model, unifying heterogeneous input modalities, exploiting user emotion as a computational signal, and adaptively reordering or refining outputs based on accumulated interaction data, thereby increasing accuracy, stability, and computational efficiency in computer-implemented information classification and identification.

The term “processor” refers to one or more hardware computation units, such as a central processing unit, a graphics processing unit, or a programmable logic device, that execute machine-readable instructions to perform information processing operations described in the claims.

The term “user terminal” refers to an electronic apparatus operated by a user, such as a mobile communication device, a portable information processing device, or a stationary information processing device, that is configured to transmit information to and receive information from the server.

The term “image information” refers to digital data representing a visual scene, including still images or image frames that depict a target object, and that can be processed by an image processing algorithm.

The term “character information” refers to digital data representing text or symbols, including natural language sentences, product descriptions, identifiers, or other textual content input by a user or obtained through recognition processing.

The term “target object” refers to an entity to be processed by the system, such as a physical article, a service, or a place, for which classification information or identification information is to be generated.

The term “attribute information” refers to structured or semi-structured data describing features or properties of the target object, including but not limited to names, descriptions, categories, visual features, or recognized text derived from image information or character information.

The term “image processing” refers to computational operations that transform, analyze, or interpret image information, including operations such as resizing, color conversion, feature extraction, object detection, and character recognition.

The term “natural language processing” refers to computational techniques for analyzing, understanding, or generating human language, including operations such as tokenization, part-of-speech tagging, syntactic parsing, semantic analysis, and keyword extraction applied to character information.

The term “emotion information” refers to data indicating an estimated emotional state of a user, such as positive, negative, neutral, or more fine-grained affective categories, that is obtained through emotion analysis of user-provided information.

The term “emotion analysis” refers to processing that estimates an emotional state from input data, including analysis of text, audio, or other signals to derive emotion information such as sentiment polarity, emotion category, or emotion intensity.

The term “prompt sentence” refers to a textual instruction or query generated by the processor and supplied to a generative AI model, the instruction or query specifying how the generative AI model is to classify, tag, or otherwise process information regarding the target object.

The term “generative AI model” refers to a machine learning model trained to generate information, including natural language text, in response to input data, and capable of producing classification information, identification information, or other outputs based on a prompt sentence.

The term “response information” refers to output data generated by the generative AI model in response to a prompt sentence, the output data including textual or structured content from which classification information or identification information is derived.

The term “classification information” refers to data that indicates one or more categories or classes assigned to the target object, such as product categories, service categories, or other group labels usable for organizing or searching information.

The term “identification information” refers to data that distinguishes or characterizes the target object, including tags, labels, or identifiers that facilitate retrieval, filtering, or recognition of the target object.

The term “stored information” refers to data retained in a storage device accessible by the processor, including historical interaction data, user selections, corrected tags, classification records, or other information used for learning or adjustment.

The term “update result” refers to data that reflects modification of classification information or identification information based on user selection or correction, and that is stored in association with stored information for later use.

The term “learning” refers to a computational process in which the processor adjusts parameters, models, or rules based on stored information, user interaction data, or other training data, in order to improve future prompt generation or output ordering.

The term “output order” refers to a presentation sequence of classification information or identification information, including ranking or prioritization applied before transmitting the information to the user terminal.

The term “integration result” refers to data obtained by combining attribute information extracted from image information with attribute information extracted from character information, the combined data serving as a basis for generating a prompt sentence.

The term “expression content in the prompt sentence” refers to the textual wording, structure, or phrasing included in the prompt sentence, such as instructions, constraints, or contextual descriptions provided to the generative AI model.

The term “condition specification in the prompt sentence” refers to explicit constraints, requirements, or parameters described in the prompt sentence, such as a requested number of tags, desired output format, or target level of detail.

In one embodiment, a server, a terminal, and a user cooperate to implement the claimed system. The server includes at least one processor, a memory, a network interface, and a non-transitory computer-readable storage device. The terminal includes a processor, a display, an input interface, and optionally an image sensor such as a camera. The user operates the terminal to provide information to the server and to review and correct classification information and identification information generated by the server.

The server executes a program that is stored in the storage device and loaded into the memory. The program is implemented, for example, in a high-level language such as a scripting language or a compiled language and runs on an operating system. The program is modularized into a communication module, an image processing module, a natural language processing module, an emotion analysis module, a prompt generation module, a generative AI interaction module, a learning and ranking module, and a storage management module.

The server uses the communication module to receive, from the terminal, image information or character information regarding a target object. The target object can be, for example, a merchandise item, a service, or a facility for which categories and tags are to be generated.

The server receives the data via a network protocol such as HTTP or HTTPS. The data is encapsulated, for example, in a request with headers and a body. The image information is stored as digital image files such as JPEG or PNG in the storage device, and the character information is stored as character strings encoded in a character encoding such as UTF-8.

The server uses the image processing module to perform data processing on the image information. The server uses an image processing library such as OpenCV to read the image into a multi-dimensional array structure representing pixel values. The server converts color spaces (for example, from BGR to RGB), normalizes image size, and applies noise reduction filters. The server further applies feature extraction algorithms such as edge detection, keypoint detection, and local descriptor computation. The server may apply an optical character recognition engine such as a generic OCR library to the image regions that are likely to contain text, thereby generating character information such as product names, descriptions, or numeric codes.

The server uses the natural language processing module to perform data processing on the character information. The server uses a natural language processing library such as spaCy or NLTK to tokenize the string into tokens, perform part-of-speech tagging, and parse syntactic structures. The server converts the token sequence into an internal representation, for example, a sequence of integer token identifiers and associated feature vectors. The server extracts attribute information such as named entities, noun phrases, adjectives, and context-specific keywords describing properties of the target object.

The server uses the emotion analysis module to estimate emotion information indicating an emotional state of the user from the character information. The server may use a sentiment analysis model implemented with a transformer-based architecture, such as a bidirectional encoder network trained with supervised learning on sentiment-labeled corpora. The server encodes the input tokens into embedding vectors, passes them through multiple layers of self-attention and feed-forward computation with learned weights, and obtains a fixed-length representation at a classification token. The server applies a linear layer and softmax activation to obtain probability values for labels such as positive, negative, or neutral, or for more fine-grained emotion labels. The server may also apply simpler models, such as a logistic regression classifier trained on bag-of-words features, or a recurrent neural network, depending on the resource constraints.

The server uses the prompt generation module to synthesize a prompt sentence based on the extracted attribute information and the emotion information. The server maintains an internal data structure representing attribute information as key-value pairs or feature objects, for example, product_name, product_features, usage_context, and emotion_label. The server applies hand-crafted or learned rules to convert these key-value pairs into natural language constructions. For example, the server concatenates fixed template segments and variable segments as follows:
“Product name: Organic Shampoo. Description: Sulfate-free shampoo with natural lavender extract for sensitive skin. Detected sentiment: positive. As a generative AI model, propose the best product categories and five relevant tags.”

The server may vary the wording and conditions in the prompt sentence depending on the emotion information. When the emotion information indicates a highly positive sentiment, the server can strengthen instructions to emphasize features that positively correlate with satisfaction. When the emotion information indicates a negative sentiment, the server can adjust the prompt sentence to explicitly request categories and tags reflecting issues or concerns, thereby guiding the generative AI model to focus on relevant aspects. This dynamic adjustment of the prompt sentence changes not only the natural language wording but also explicit constraints, such as the number of categories, the type of tags, or the level of detail, which in turn affects the internal computation paths in the generative AI model.

The server uses the generative AI interaction module to transmit the prompt sentence to a generative AI model and to receive response information from the generative AI model. The generative AI model may reside on the same server hardware, on a dedicated accelerator device, or on a remote computation node accessible via a network. In one embodiment, the generative AI model is a transformer-based language model comprising an input embedding layer, multiple encoder or decoder blocks, attention mechanisms, and an output projection layer. Each block applies multi-head self-attention and position-wise feed-forward networks with non-linear activation functions. The generative AI model is pre-trained on large corpora and optionally fine-tuned on domain-specific data including pairs of prompt sentences and desired classification outputs.

The server converts the prompt sentence into token identifiers consistent with the generative AI model's vocabulary and feeds these identifiers into the generative AI model. The generative AI model iteratively generates tokens for an output sequence, using techniques such as greedy decoding, beam search, or sampling. The server receives the generated token sequence and decodes it into response information in natural language text. The response information may include candidate categories, tags, and explanatory text.

The server uses the learning and ranking module to convert the raw response information into classification information and identification information that are suitable for presentation to the user. The server applies pattern matching or regular expression processing to extract segments labeled as categories or tags from the response information. The server normalizes the extracted segments, for example, by converting them to a canonical case, removing punctuation, or mapping synonyms to a controlled vocabulary stored in the storage device.

The server assigns each category and tag a feature vector representing its semantic meaning, which may be computed using word embeddings or sentence embeddings.

The server uses historical data stored as stored information to learn preferences and to optimize output ordering. The stored information includes update results, such as which tags users have accepted, rejected, or modified in the past in similar contexts. The server trains a ranking model, for example, a gradient boosting machine or a neural network, that receives features derived from the prompt sentence, response information, emotion information, and candidate categories and tags, and outputs a relevance score. The server then orders the candidate categories and tags according to these scores, thereby improving the probability that the most relevant suggestions appear at the top of the list.

The server uses the storage management module to save update results in association with the stored information. When the user corrects a tag or selects specific categories, the terminal sends the correction to the server. The server writes a structured record containing the original prompt sentence, the original response information, the final user-approved classification information and identification information, the emotion information, and context metadata into a database. The server periodically or incrementally retrains the ranking model and, where applicable, fine-tunes the generative AI model using these records as supervised training examples, thereby reducing classification error and improving convergence over time.

The terminal presents the classification information and identification information to the user.

The terminal displays the information using graphical interface components, such as selectable labels or buttons, on the display. The terminal receives user input via touch, keyboard, voice, or other input means, and transmits the input back to the server. The terminal may also guide the user to provide more informative inputs by, for example, prompting the user to add a short description if the automatically inferred tags are ambiguous.

The user operates the terminal in various application scenarios. In a retail context, the user uses the camera of the terminal to capture an image of a product on a shelf. The terminal sends the image to the server. The server extracts attribute information, generates a prompt sentence including the product name, features, and the user's emotion (inferred from optional feedback), and then calls the generative AI model. The server receives response information containing categories such as “Hair Care” and tags such as “organic”, “sulfate-free”, and “lavender”. The terminal displays these categories and tags, enabling the user to quickly register the product or to locate similar products.

In a service-search context, the user enters a request such as:
“I want a place for a fun family dinner where everyone can relax.”

The terminal sends this text to the server. The server performs natural language processing and emotion analysis, recognizing an overall joyful and relaxed sentiment and extracting attribute information such as “family”, “dinner”, and “relax”. The server generates the following prompt sentence:
“User text: ‘I want a place for a fun family dinner where everyone can relax.’ Detected emotion: joyful and relaxed. As a generative AI model, list categories and tags that best describe suitable restaurants for this request.”

The generative AI model generates response information such as:
“Categories: Family Restaurant, Casual Dining. Tags: family-friendly, relaxing, cozy, fun, dinner, child-friendly.”

The server ranks and refines these outputs based on historical user behavior. The terminal displays the refined categories and tags, thereby allowing the user to filter search results efficiently.

The server improves computer technology in several ways. First, the server improves processing efficiency by structuring inputs into optimized prompt sentences that reduce unnecessary output variance from the generative AI model. This structured prompting allows the generative AI model to converge on desired types of outputs more quickly, reducing the number of tokens generated and thus lowering computational load and network bandwidth usage. Second, the server improves accuracy by integrating attribute information from both image information and character information into a single representation before prompt generation. This fused representation contains more discriminative features for the target object than either source alone, which improves classification precision and reduces errors. Third, the server uses emotion information as an additional computational feature, not merely for user interface customization. By feeding emotion information into the prompt generation and ranking processes, the server modifies the internal processing paths of the generative AI model and the ranking model. This modification leads to a reduction in user corrections and a corresponding reduction in repeated network requests and reprocessing. Fourth, the server uses learning-based ranking to adjust output ordering over time. This ranking mechanism, implemented with a specific machine learning algorithm operating over structured feature vectors, is not a simple automation of human judgment but a concrete algorithmic improvement that transforms stored interaction data into more effective future behavior.

In one variation, the server deploys the generative AI model on hardware accelerators such as graphics processors or tensor processing units. The server batches multiple prompt sentences into a mini-batch and processes them in parallel to increase throughput. The server uses an optimization technique to select a decoding strategy for the generative AI model based on the complexity of the prompt sentence and the expected output length, which further reduces computational overhead.

In another variation, the server replaces or augments the transformer-based generative AI model with other architectures such as sequence-to-sequence recurrent neural networks or hybrid models combining rule-based constraints with neural generation. The server can apply explicit constraints during decoding, such as forcing output to contain a predetermined number of category labels, which is implemented by masking invalid tokens at each decoding step. The server thereby enforces output structures that are more directly usable for downstream modules, reducing the need for post-processing and improving latency.

In another variation, the server employs a data augmentation method when training internal models such as the sentiment classifier or the ranking model. The server generates synthetic training examples by paraphrasing prompt sentences, swapping synonyms in attribute information, or adding noise to emotion labels. The server calculates loss functions such as cross-entropy between predicted labels and ground truth, and updates model weights using gradient-based optimization methods. This training process improves the robustness of the system against real-world variations in user input.

The described system is not limited to any particular application domain. The target object can be any entity represented by image information or character information, including products, services, events, documents, or media content. The same architectural principles apply: the server extracts attribute information, generates a prompt sentence, interacts with a generative AI model, learns from user corrections, and uses emotion information to guide technical processing. Because these operations are deeply embedded in the data structures, algorithms, and model architectures executed inside the computing devices, the effects of the invention manifest as concrete improvements in computational performance, classification accuracy, and resource efficiency, rather than as an abstract idea implemented on a generic computer.

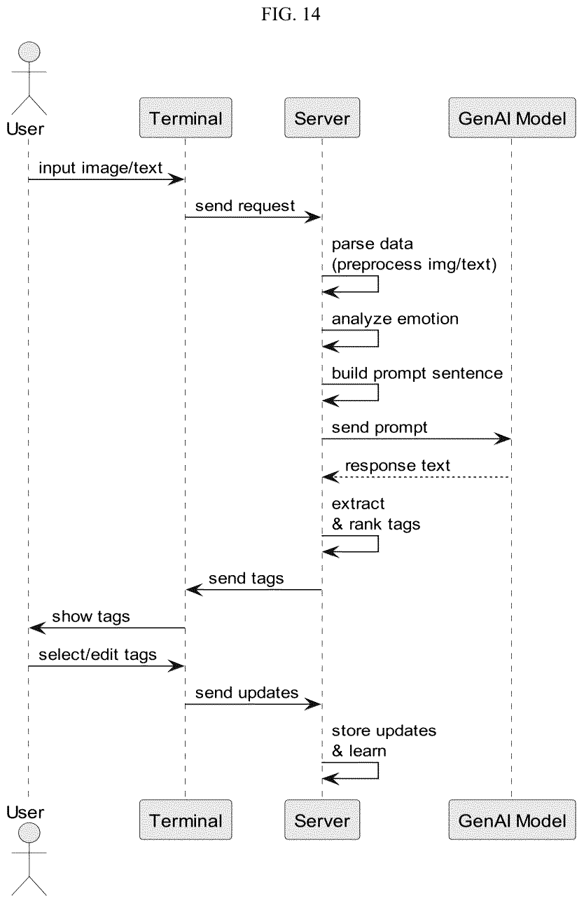

The following describes the processing flow using FIG. 14.

### Step 1:

User operates the terminal to provide initial information.

User inputs information regarding a target object by one or more of: capturing an image of the target object using a camera of the terminal, typing a text description into an input field of the terminal, or selecting existing text from a list displayed on the terminal. The input is raw sensor data (for the image) or raw character data (for the text). The output is structured request data including at least one of image information and character information, together with metadata such as time, location, and user identifier, which the terminal stores temporarily in memory.

### Step 2:

Terminal transmits the request data to the server.

Terminal reads the structured request data from local memory, encapsulates the data in a network message using a protocol such as HTTP or HTTPS, and attaches headers that identify the type of data (image or text). The input is the structured request data produced in Step 1. The output is a network packet stream carrying the request data, which the terminal sends to the server via a communication interface such as Wi-Fi or a mobile network.

### Step 3:

Server receives the request and separates image information and character information.

Server uses a communication module to accept the network packet stream and reconstruct the request message. Server parses the message body to extract the image information and the character information, and stores them in corresponding data structures in memory (for example, a byte array for the image and a string buffer for the text). The input is the network message from the terminal. The output is an internal representation containing at least one of a digital image object and a text object associated with the target object.

### Step 4:

Server performs image preprocessing and feature extraction when image information is present.

Server invokes an image processing module to load the digital image object into a multidimensional array, converts the color space, resizes the image to a normalized resolution, and applies denoising filters. Server then executes feature extraction algorithms, such as edge detection or keypoint detection, to derive numerical feature vectors describing visual properties of the target object. The input is the digital image object stored in memory. The output is preprocessed image data and one or more visual feature vectors that represent candidate regions, shapes, or patterns relevant to the target object.

### Step 5:

Server performs text preprocessing and linguistic analysis when character information is present.

Server invokes a natural language processing module to tokenize the text object into tokens, assigns part-of-speech tags to each token, and parses syntactic structures using a parser.

Server then identifies named entities, noun phrases, and adjectives and converts these elements into symbolic features such as key phrases and attribute terms. The input is the raw text object representing character information. The output is a set of linguistic features, including tokenized sequences, part-of-speech tags, dependency relations, and extracted attribute terms corresponding to properties of the target object.

### Step 6:

Server executes optical character recognition when text is embedded in the image.

Server applies an optical character recognition engine to candidate text regions in the preprocessed image data. Server segments the image into bounding boxes likely to contain text, converts each region to a normalized grayscale image, and decodes character sequences by matching visual patterns to a character recognition model. The input is the preprocessed image data and the visual feature vectors from Step 4. The output is additional character information derived from the image, such as a product name or description string, which the server merges into the text object used for further analysis.

### Step 7:

Server generates unified attribute information from visual and textual features.

Server combines the visual feature vectors and the linguistic features, using mapping rules or a learned fusion model, to produce unified attribute information. Server aligns image-derived attributes (for example, detected logos or shapes) with text-derived attributes (for example, brand names or categories) and resolves conflicts by applying predetermined priority rules or similarity scores. The input is the image feature set from Step 4 and Step 6 and the linguistic feature set from Step 5. The output is a unified attribute structure, such as a key-value map, including fields like target_object_name, target_object_type, feature_keywords, and context_terms.

### Step 8:

Server performs emotion analysis to derive emotion information from user-provided text.

Server passes the tokenized text sequence and associated linguistic features into an emotion analysis model, such as a neural classifier using embedded word vectors and multiple attention layers. Server computes an emotion score vector by applying a softmax function over the model's output logits, and selects one or more dominant emotion labels based on thresholding or maximum probability. The input is the processed text data, including tokens and syntactic features. The output is emotion information, comprising an emotion label (for example, positive, negative, joyful, relaxed) and optional intensity values used as numerical features in later steps.

### Step 9:

Server constructs a base prompt sentence from attribute information.

Server uses the unified attribute structure to generate a base prompt template. Server selects specific fields, such as target_object_name and feature_keywords, and inserts them into a fixed textual frame including instructions for classification. The input is the unified attribute information generated in Step 7. The output is a base prompt sentence in natural language that describes the target object and requests classification, for example: “Product name: Organic Shampoo. Description: Sulfate-free shampoo with natural lavender extract for sensitive skin. As a generative AI model, propose the best product categories and five relevant tags.”

### Step 10:

Server adjusts the prompt sentence using emotion information.

Server modifies the base prompt sentence by appending explicit emotion context and changing or adding constraint clauses based on the emotion information. Server may add text such as “Detected sentiment: positive” and alter the requested output focus, such as emphasizing satisfaction or concerns. The input is the base prompt sentence from Step 9 and the emotion information from Step 8. The output is an adjusted prompt sentence, for example: “Product name: Organic Shampoo. Description: Sulfate-free shampoo with natural lavender extract for sensitive skin. Detected sentiment: positive. As a generative AI model, propose the best product categories and five relevant tags that reflect this sentiment.”

### Step 11:

Server encodes the prompt sentence and invokes the generative AI model.

Server converts the adjusted prompt sentence into a sequence of token identifiers using a tokenizer specific to the generative AI model. Server passes the token sequence, along with positional encodings, into the generative AI model executed on a processor or accelerator. The generative AI model performs matrix multiplications, attention operations, and non-linear transformations across multiple layers to compute output token probabilities. The input is the tokenized prompt sequence and model parameters. The output is a sequence of output token distributions, which the server decodes into a generated text response by applying a decoding strategy such as greedy selection or beam search.

### Step 12:

Server extracts candidate categories and tags from the model response.

Server receives the generated text response and applies pattern recognition rules, such as searching for lines prefixed with “Categories:” or “Tags:”, or uses regular expressions to isolate lists of labels. Server splits the lists by delimiters, trims whitespace, and removes redundant or malformed entries. The input is the raw response text from the generative AI model. The output is a structured list of candidate classification information and identification information, containing one or more category labels and tag labels for the target object.

### Step 13:

Server normalizes and semantically represents candidate labels.

Server converts each candidate label to a normalized canonical form, such as converting to lowercase, removing accents, and mapping synonyms to standard vocabulary entries stored in a database. Server computes semantic vectors for each label, using pre-trained language embeddings or domain-specific embedding models, and attaches these vectors to the labels for use in ranking. The input is the list of candidate categories and tags from Step 12. The output is a set of normalized labels with associated semantic feature vectors.

### Step 14:

Server ranks candidate labels using historical stored information.

Server retrieves stored information that includes past user selections and corrections for similar attribute patterns and emotion states. Server constructs feature vectors for each candidate label that combine semantic embeddings, prompt attributes, emotion attributes, and historical statistics such as acceptance frequency. Server applies a ranking model, such as a gradient boosted tree or a neural scoring function, to compute a relevance score for each label. The input is the normalized labels with feature vectors and the stored information. The output is an ordered list of labels, where labels with higher scores appear earlier and thus are more likely to be useful to the user.

### Step 15:

Server generates a response message and sends it to the terminal.

Server groups the ranked labels into categories and tags, formats them into a structured response, and may attach explanations or confidence scores if required. Server constructs a network response message including the ordered classification information and identification information and transmits this message back to the terminal via the communication module. The input is the ordered list of labels from Step 14. The output is a response message that the terminal can decode and display.

### Step 16:

Terminal displays suggested categories and tags to the user.

Terminal parses the response message received from the server and maps the classification information and identification information to interactive user interface elements, such as selectable chips or checkboxes. Terminal renders these elements on the display along with optional indicators of ranking or confidence. The input is the response message from Step 15. The output is a rendered user interface state, in which the user can visually identify the suggested categories and tags and interact with them.

### Step 17:

User reviews, selects, and edits the proposed labels.

User observes the displayed categories and tags, taps or clicks to select relevant ones, deselects incorrect ones, or edits text fields to refine label wording. The input is the visual and interactive interface presented by the terminal. The output is user interaction events, such as selection, deselection, or text modification operations, captured by the terminal.

### Step 18:

Terminal transmits user corrections and confirmations to the server.

Terminal aggregates the user interaction events into an update structure that describes which labels were accepted, rejected, or modified. Terminal sends this update structure to the server as a follow-up request. The input is the user interaction events from Step 17. The output is an update message carrying the final classification information and identification information as confirmed by the user.

### Step 19:

Server stores update results and refines stored information.

Server receives the update message and creates a new record that links the original prompt sentence, the generated response, the final user-approved labels, and the emotion information. Server writes this record into a storage system such as a relational database or a key-value store. Server updates aggregated statistics for each label, such as acceptance counts and correction patterns, and schedules or performs retraining of internal models using the newly stored data. The input is the update message from Step 18. The output is updated stored information used to improve future prompt sentence generation, generative AI model fine-tuning, and ranking behavior.

### Step 20:

Server updates internal models to improve future processing.

Server periodically or incrementally feeds the stored records into training procedures for the emotion analysis model, the ranking model, and optionally the generative AI model. Server computes loss functions, such as cross-entropy between predicted and actual labels, and updates model parameters via gradient descent or related optimization algorithms. The input is the collection of stored records and current model parameters. The output is updated model parameters that cause subsequent processing flows to produce more accurate, stable, and efficient classification and identification results, thereby reducing computational redundancy and improving overall system performance.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

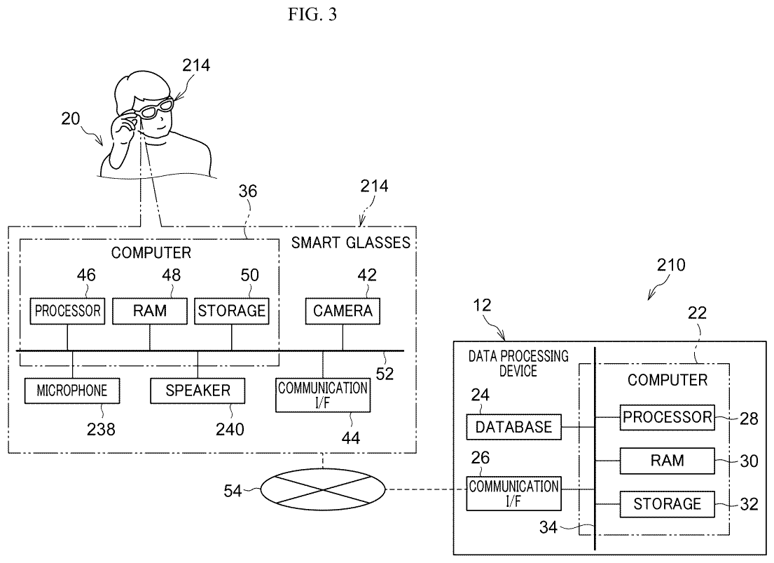

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

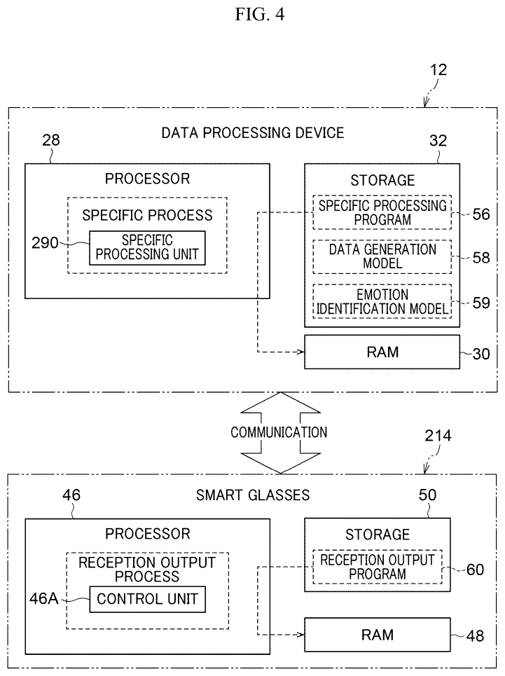

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

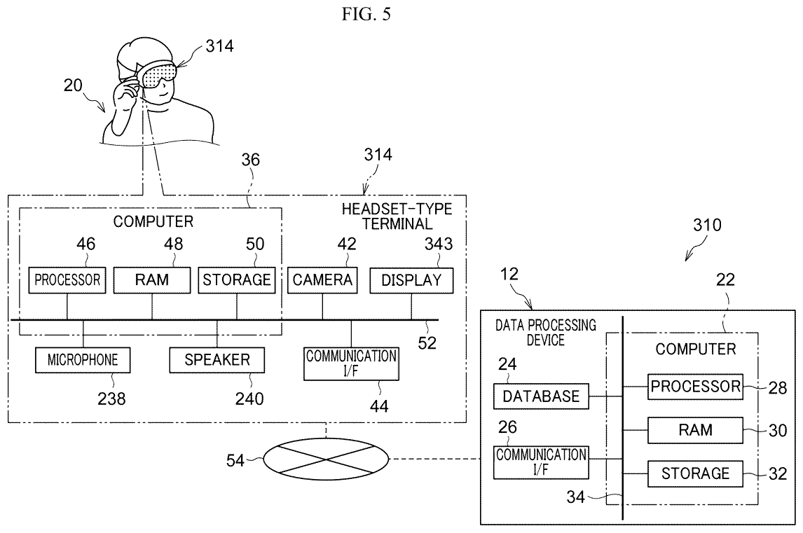

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

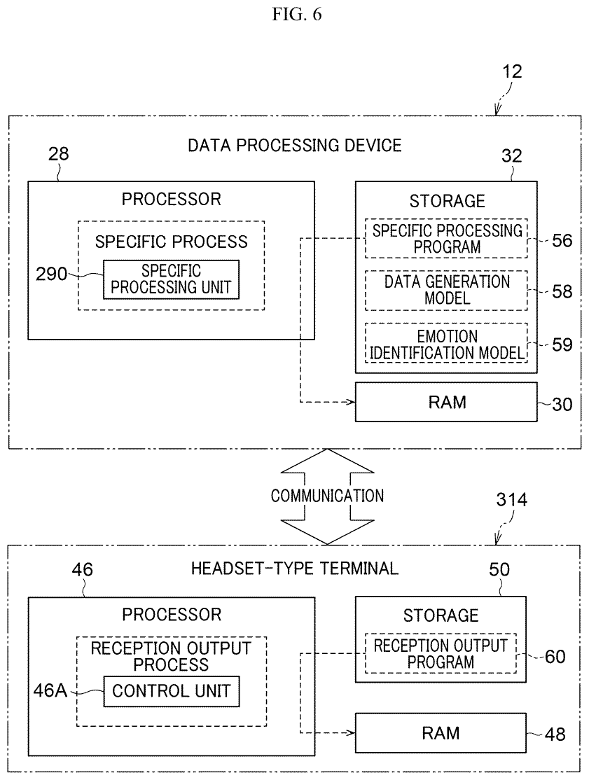

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

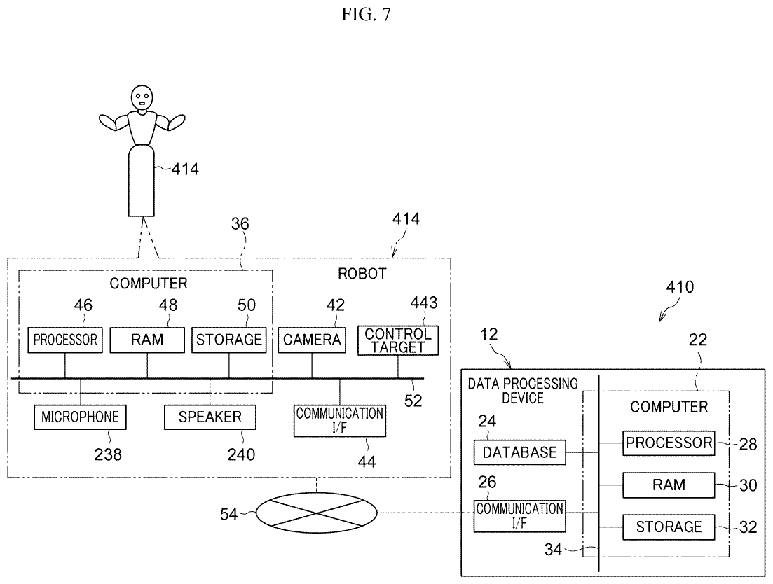

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

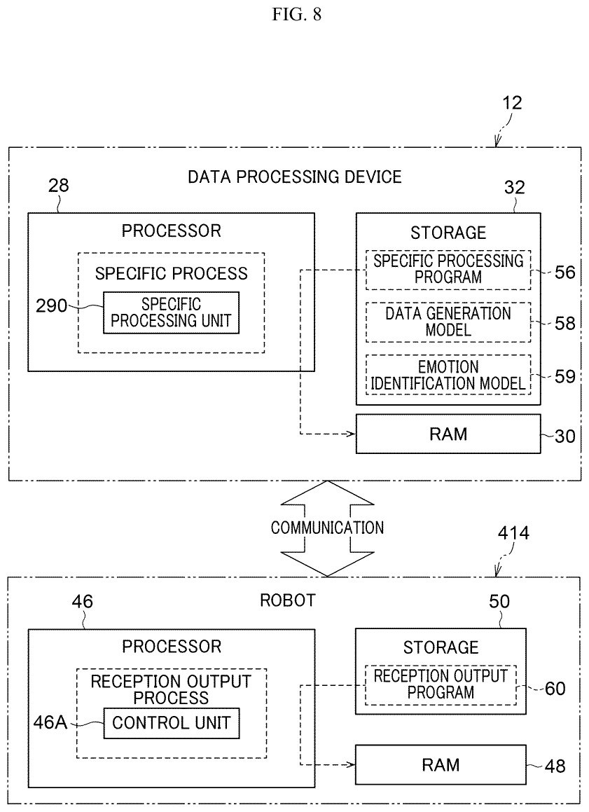

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

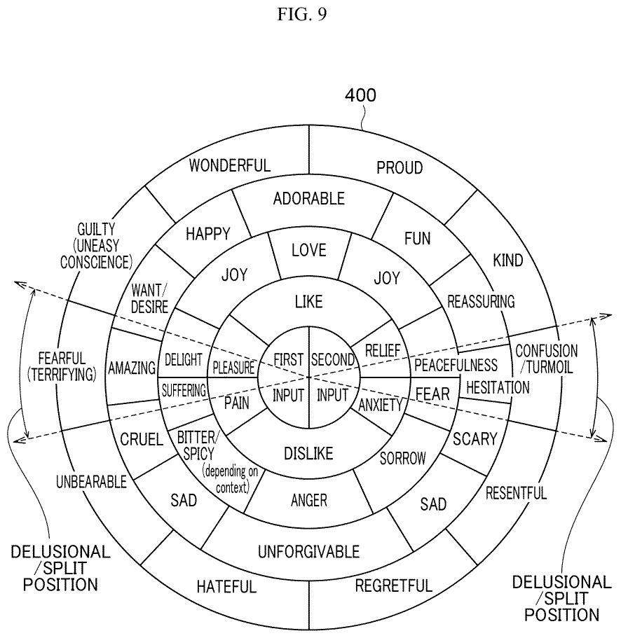

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

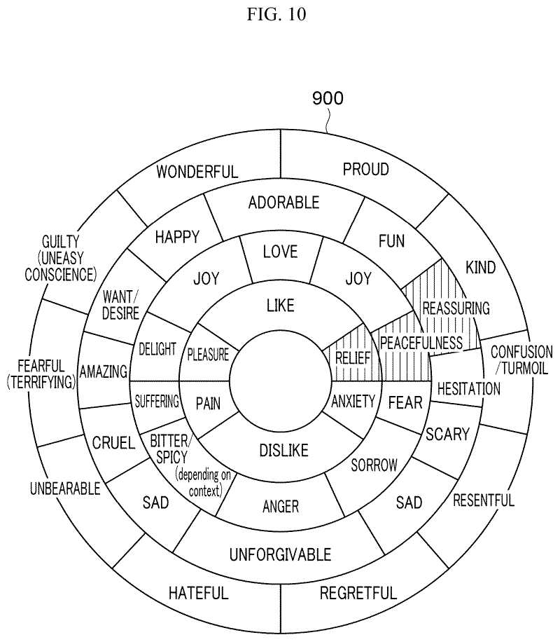

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive character information from a user through an information input unit,
preprocess the received character information by performing natural language processing including morphological analysis and removal of unnecessary terms by using an analysis unit,
generate a feature quantity by creating a weighted vector from the preprocessed character information by using a feature extraction unit,
estimate at least one category and at least one tag by inputting the weighted vector into a classification learning unit,
generate a prompt sentence that describes processing contents for estimating the category and the tag, and generate instruction information for inputting the prompt sentence into a generative information processing model by using a prompt generation unit,
select candidates for the category and the tag based on response information returned from the generative information processing model, and integrate the candidates with an estimation result from the classification learning unit to determine the category and the tag as proposal information by using an integration unit,
present the determined category and tag to the user via a display unit, and receive correction input from the user by using a user interface unit, and
store the proposal information as confirmed information in a storage unit based on the correction input from the user, and save the confirmed information in a format usable as training data for the classification learning unit and the generative information processing model by using a storage control unit.

### Supplementary 2

The system according to supplementary 1,
wherein the processor is configured to
dynamically change contents and a format of the prompt sentence so as to include character information related to a commercial entity or a product, the feature quantity, the estimation result of the classification learning unit, and past confirmed information by the user, and input the changed prompt sentence into the generative information processing model to cause the generative information processing model to generate candidates for the category and the tag.

### Supplementary 3

The system according to supplementary 1,
wherein the processor is configured to
estimate an emotional state of the user based on operation history information or reaction information of the user, adjust vocabulary, style, and request conditions of the prompt sentence according to the emotional state, and control a type and a number of the candidates for the category and the tag obtained from the generative information processing model.

Application Example 1

### Supplementary 1

A system comprising a processor,
wherein the processor is configured to
receive character information including identification information relating to an item or a service from a user terminal, and record the received character information via an external input/output function,
preprocess the received character information by using a natural language processing technique, the preprocessing including at least morphological analysis, phrase segmentation, part-of-speech assignment, and feature extraction, and generate numerical feature data for classification processing from the preprocessed character information,
generate a prompt sentence including an instruction statement for estimating at least one category or tag in a commerce environment on the basis of the character information and the numerical feature data, and format the prompt sentence as input data for a generative artificial intelligence model,
operate the generative artificial intelligence model on a machine learning platform, execute matrix computation and probability estimation processing based on the input data, and obtain classification result data including candidate categories and candidate tags and confidence information corresponding to the candidate categories and the candidate tags,
perform ranking and threshold determination on the classification result data on the basis of the confidence information, perform normalization processing including association with internal identifiers, and generate classification candidate information for the item or the service,
transmit the classification candidate information to the user terminal and cause a display function of the user terminal to present the classification candidate information as selectable candidates,
obtain final classification information including a correction result or an approval result received from a user, register the final classification information in a storage device in association with the item or the service, and accumulate the obtained final classification information together with the character information and the prompt sentence as learning history data, and
retrain or adjust performance of the generative artificial intelligence model on the basis of the accumulated learning history data, and reflect an update result of the retraining or the adjustment in subsequent classification processing.

### Supplementary 2

The system according to supplementary 1,
wherein the processor is configured to input the generated prompt sentence and the numerical feature data into the generative artificial intelligence model, select a plurality of categories and tags as candidates on the basis of the classification result data returned from the generative artificial intelligence model, obtain a selection operation result of the candidates from the user as the final classification information, and register the final classification information as part of an item registration process or an information update process.

### Supplementary 3

The system according to supplementary 1,
wherein the processor is configured to analyze response information and operation history information of the user obtained from the user terminal, dynamically adjust at least one of instruction content, level of detail, and output format of the generated prompt sentence on the basis of an analysis result, and control generation processing of the classification candidate information so as to optimize at least one of a type and a number of the categories and the tags proposed by the generative artificial intelligence model.

### Example 2

### Supplementary 1

A system comprising a processor and a memory storing instructions which, when executed by the processor, cause the processor to:
receive character information from a user terminal;
perform preprocessing on the received character information by using a language processing program executed on a general-purpose information processing apparatus, the preprocessing including dividing the character information into word units, removing unnecessary terms, and generating a set of normalized character strings;
perform, based on the set of normalized character strings, similarity computation with respect to reference information stored in an information storage apparatus, the similarity computation including calculating a similarity index based on at least one of occurrence frequency information of character strings and distributed representations, and extracting candidate information based on the similarity index;
aggregate classification information and additional information associated with the candidate information, weight the classification information and the additional information in accordance with the similarity index, and estimate primary classification information and primary additional information for the received character information based on the weighted aggregation;
generate an explanatory character string including at least the primary classification information, the primary additional information, and the received character information, and construct a prompt sentence by formatting the explanatory character string as an input format for a generative information processing model;
input the prompt sentence into an internal or external generative information processing model, analyze a response character string output from the generative information processing model, verify the primary classification information and the primary additional information based on the response character string, and determine confirmed classification information and confirmed additional information including corrected or added classification information and additional information;
transmit the confirmed classification information and the confirmed additional information as presentation data to the user terminal, and receive a confirmation input or a correction input from a user via the user terminal; and
store final classification information and final additional information in the information storage apparatus based on the confirmation input or the correction input.

### Supplementary 2

The system according to supplementary 1,
wherein the processor is configured to include, in the prompt sentence, an instruction specifying that the response character string from the generative information processing model is to be provided in a machine-readable array representation, and to parse the response character string as structured data in the machine-readable array representation so as to automatically extract the confirmed classification information and the confirmed additional information.

### Supplementary 3

The system according to supplementary 1,
wherein the processor is configured to estimate a user state based on at least one of the character information input from the user and an operation history acquired from the user terminal, and to change instruction content or output conditions in the prompt sentence in accordance with the estimated user state so as to adjust content of the classification information and the additional information output from the generative information processing model.

### Application Example 2

### Supplementary 1

A system comprising a processor,
wherein the processor is configured to
receive, from a user terminal, image information or character information regarding a target object to be processed,
extract attribute information regarding the target object by applying image processing to the image information, or extract attribute information regarding the target object by applying natural language processing to the character information,
generate a prompt sentence including an instruction statement for classifying the target object, based on the extracted attribute information and emotion information indicating an emotional state of a user, for input to a generative AI model,
input the prompt sentence to the generative AI model and generate classification information or identification information related to the target object, based on response information obtained from the generative AI model,
transmit the classification information or the identification information to the user terminal, update the classification information or the identification information in accordance with selection or correction input from the user, and store an update result in association with stored information, and
adjust, by learning, generation of the prompt sentence or an output order of the classification information or the identification information, based on the stored information.

### Supplementary 2

The system according to supplementary 1,
wherein the processor is configured to
integrate the attribute information extracted from the image information and the attribute information extracted from the character information, and generate the prompt sentence based on an integration result so as to improve estimation accuracy of the classification information or the identification information by the generative AI model.

### Supplementary 3

The system according to supplementary 1,
wherein the processor is configured to
perform emotion analysis processing on information acquired from the user, change an expression content or condition specification in the prompt sentence based on the emotion information, and input the changed prompt sentence to the generative AI model so as to dynamically adjust the classification information or the identification information proposed in accordance with the emotion information.

What is claimed is:

1. A system comprising:
circuitry configured to:
acquire, via a communication interface coupled to a packet-switched network, input data comprising a sequence of character symbols transmitted from a terminal device;
perform preprocessing on the input data by segmenting the sequence of character symbols into token units, removing tokens matching a predetermined exclusion list, and generating a normalized token set;
compute a feature vector from the normalized token set and input the feature vector into a classification model to generate preliminary inference data;
construct a prompt data structure comprising the preliminary inference data and the normalized token set, and transmit the prompt data structure to a generative neural network model to obtain response data comprising structured label candidates;
integrate the structured label candidates with the preliminary inference data to determine output label data, and transmit the output label data to the terminal device via the packet-switched network; and
receive correction data from the terminal device and store confirmed label data in a storage device as training data for updating the classification model.

2. The system according to claim 1, wherein the circuitry is configured to perform the preprocessing by executing morphological analysis on the sequence of character symbols to divide the sequence into word-level token units, assigning a part-of-speech label to each word-level token unit, and extracting phrase boundaries from the part-of-speech labels to generate the normalized token set as a structured sequence of phrase segments.

3. The system according to claim 2, wherein the circuitry is configured to construct the prompt data structure by including in the prompt data structure an instruction statement specifying a response format as a machine-readable array representation, the preliminary inference data, and a confidence threshold parameter, and to parse the response data from the generative neural network model as the machine-readable array representation to extract the structured label candidates with associated confidence scores.

4. The system according to claim 3, wherein the circuitry is configured to perform ranking on the structured label candidates on the basis of the associated confidence scores, apply the confidence threshold parameter to exclude candidates below the confidence threshold parameter, perform normalization processing including association of each remaining candidate with an internal identifier, and generate the output label data as classification candidate information comprising at least one category and at least one tag for an item or a service.

5. The system according to claim 4, wherein the circuitry is configured to transmit the classification candidate information to the terminal device as selectable candidates displayed via a user interface, obtain final classification information comprising a selection result or a correction result from the terminal device, register the final classification information in the storage device in association with the item or the service, and accumulate the final classification information together with the input data and the prompt data structure as learning history data for retraining the generative neural network model.

6. The system according to claim 1, wherein the circuitry is configured to acquire operation history data or reaction data from the terminal device via the packet-switched network, and estimate an emotional state of an operator of the terminal device by inputting the operation history data or the reaction data into an emotion identification model stored in the storage device.

7. The system according to claim 6, wherein the circuitry is configured to adjust at least one of vocabulary, style, and request conditions of the prompt data structure in accordance with the estimated emotional state, and control a type and a number of the structured label candidates obtained from the generative neural network model on the basis of the adjusted prompt data structure.

8. The system according to claim 7, wherein the circuitry is configured to dynamically change contents and a format of the prompt data structure so as to include the input data, the feature vector, the preliminary inference data, past confirmed label data stored in the storage device, and an emotion parameter derived from the estimated emotional state, and transmit the changed prompt data structure to the generative neural network model to generate the structured label candidates adapted to a current state and a preference of the operator.

9. The system according to claim 1, wherein the circuitry is configured to acquire, via the communication interface, image data transmitted from the terminal device, and extract attribute data from the image data by applying image processing comprising object detection and feature extraction to the image data.

10. The system according to claim 9, wherein the circuitry is configured to integrate the attribute data extracted from the image data with attribute data extracted from the input data comprising the sequence of character symbols, and construct the prompt data structure on the basis of an integration result to improve estimation accuracy of the structured label candidates generated by the generative neural network model.

11. The system according to claim 10, wherein the circuitry is configured to include in the prompt data structure emotion information indicating an emotional state of an operator of the terminal device together with the integration result, and generate classification information or identification information related to a target object depicted in the image data, on the basis of response information obtained from the generative neural network model.

12. The system according to claim 1, wherein the circuitry is configured to compute, from the normalized token set, a distributed representation vector, calculate a similarity index between the distributed representation vector and reference vectors stored in the storage device by using at least one of occurrence frequency information and distributed representations, and extract candidate reference data on the basis of the similarity index.

13. The system according to claim 12, wherein the circuitry is configured to aggregate classification information and additional attribute information associated with the candidate reference data, weight the classification information and the additional attribute information in accordance with the similarity index, and estimate primary classification information and primary additional attribute information for the input data on the basis of the weighted aggregation, and include the primary classification information and the primary additional attribute information in the prompt data structure transmitted to the generative neural network model.

14. The system according to claim 1, wherein the circuitry is configured to accumulate, in the storage device, the confirmed label data together with the input data and the prompt data structure as learning history data, and retrain or adjust parameters of the classification model and the generative neural network model on the basis of the accumulated learning history data.

15. The system according to claim 14, wherein the circuitry is configured to reflect an update result of the retraining or the parameter adjustment in subsequent preprocessing, feature vector computation, and prompt data structure construction, so as to improve accuracy of the preliminary inference data and the structured label candidates in subsequent processing cycles.

16. The system according to claim 1, wherein the circuitry is configured to transmit the output label data to the terminal device as a plurality of selectable candidate entries displayed via a graphical interface of the terminal device, and receive, from the terminal device, a selection input or a correction input indicating a final determination among the plurality of selectable candidate entries.

17. The system according to claim 16, wherein the circuitry is configured to register the final determination in the storage device in association with identification information of an item or a service described by the input data, and save the final determination together with the input data in a format usable as training data for the classification model and the generative neural network model.

18. A system comprising:
circuitry configured to:
acquire, via a communication interface coupled to a packet-switched network, input data comprising a sequence of character symbols from a terminal device, perform morphological analysis on the sequence of character symbols to divide the sequence into word-level token units, assign a part-of-speech label to each word-level token unit, extract phrase boundaries, and generate a normalized token set as a structured sequence of phrase segments;
generate a feature vector by computing a weighted vector from the normalized token set using a distributed representation model, and input the feature vector into a classification learning model comprising a Transformer-based encoder that computes attention weights over the feature vector using scaled dot-product attention and softmax normalization to generate preliminary inference data comprising estimated classification labels and associated confidence scores;
construct a prompt data structure comprising an instruction statement, the preliminary inference data, the normalized token set, and an emotion parameter derived from an estimated emotional state of an operator of the terminal device, format the prompt data structure as input for a generative neural network model comprising a Transformer-based decoder, transmit the prompt data structure to the generative neural network model, and receive response data comprising structured label candidates with associated confidence scores in a machine-readable array representation;
perform ranking and threshold filtering on the structured label candidates on the basis of the associated confidence scores, integrate the filtered structured label candidates with the preliminary inference data by weighted combination, and determine output label data;
transmit the output label data to the terminal device via the packet-switched network, receive correction data from the terminal device, and store confirmed label data in a storage device; and
retrain or adjust parameters of the classification learning model and the generative neural network model on the basis of the confirmed label data accumulated as learning history data, and reflect an update result of the retraining in subsequent processing.

19. The system according to claim 18, wherein the circuitry is configured to acquire image data from the terminal device via the communication interface, extract attribute data from the image data by applying object detection and feature extraction, integrate the attribute data with attribute data derived from the normalized token set, and include an integration result in the prompt data structure transmitted to the generative neural network model to generate the structured label candidates on the basis of multimodal input.

20. A method performed by circuitry of a server coupled to a packet-switched network via a communication interface, the method comprising:
acquiring, via the communication interface, input data comprising a sequence of character symbols transmitted from a terminal device;
performing preprocessing on the input data by segmenting the sequence of character symbols into token units, removing tokens matching a predetermined exclusion list, and generating a normalized token set;
computing a feature vector from the normalized token set and inputting the feature vector into a classification model to generate preliminary inference data;
constructing a prompt data structure comprising the preliminary inference data and the normalized token set, and transmitting the prompt data structure to a generative neural network model to obtain response data comprising structured label candidates;
integrating the structured label candidates with the preliminary inference data to determine output label data, and transmitting the output label data to the terminal device via the packet-switched network; and
receiving correction data from the terminal device and storing confirmed label data in a storage device as training data for updating the classification model.
